(19) United States
(12) Patent Application Publication
(10) Pub. No.: US 2019/0205189 A1
(43) Pub. Date: Jul. 4, 2019

(54) COMMUNICATION SYSTEM, TERMINAL, AND SERVER

(71) Applicant: FUJITSU LIMITED, Kawasaki-shi (JP)

(72) Inventor: Shinya Yamamura, Fukuoka (JP)

(73) Assignee: FUJITSU LIMITED, Kawasaki-shi (JP)

(21) Appl. No.: 16/299,203

(22) Filed: Mar. 12, 2019

Related U.S. Application Data
(63) Continuation of application No. PCT/JP2016/079156, filed on Sep. 30, 2016.

(51) Int. Cl. G06F 9/54; H04L 12/751; G06F 9/50; H04W 40/24; H04W 40/36

(52) U.S. Cl. CPC G06F 9/542; H04L 45/02; H04W 40/36; H04W 40/248; G06F 9/5022

(57) ABSTRACT

A communication system includes a server, in which a first application operates, configured to include a first memory, and a first processor coupled to the first memory and the first processor configured to relay communication addressed from the first application to a second application for operating in a terminal, and the terminal configured to include a second memory, and a second processor coupled to the second memory and the second processor configured to forward the communication relayed from the first application to the second application, each of the first processor and the second processor is configured to generate a communication route corresponding to a session established by communication between the first application and the second application, and maintain the session by using the communication route while switching a network that includes the terminal.

### CROSS-REFERENCE TO RELATED APPLICATION

This application is a continuation application of International Application PCT/JP2016/079156 filed on Sep. 30, 2016 and designated the U.S., the entire contents of which are incorporated herein by reference.

### FIELD

The present invention relates to a communication system, a terminal, and a server.

### BACKGROUND

A terminal device such as a smartphone is connected to a wireless network such as wireless fidelity (Wi-Fi, registered trademark, hereinafter the same) or Long Term Evolution (LTE, registered trademark, hereinafter the same), and the wireless network as the connection destination is switched as the terminal device moves. For this reason, every time the wireless network is switched, the dynamic host configuration protocol (DHCP) or the like assigns a new Internet Protocol (IP) address to the terminal device.

The session of an application using communications is managed separately from the session of a communication protocol such as Transmission Control Protocol (TCP)/IP, and unilateral communication from a server device to a terminal device such as push type communication is disrupted when the IP address of the terminal device is changed.

Regarding the session, for example, Patent Literature 1: Japanese Laid-open Patent Publication No. 2011-217198 describes a wireless terminal in which when the wireless link with a server is disconnected, the output of data packets from the buffer to the application layer is delayed to increase the time during which the application layer recognizes that the session is in the connected status.

### SUMMARY

According to an aspect of the invention, a communication system includes a server, in which a first application operates, configured to include a first memory, and a first processor coupled to the first memory and the first processor configured to relay communication addressed from the first application to a second application for operating in a terminal, and the terminal configured to include a second memory, and a second processor coupled to the second memory and the second processor configured to forward the communication relayed from the first application to the second application, each of the first processor and the second processor is configured to generate a communication route corresponding to a session established by communication between the first application and the second application, and maintain the session by using the communication route while switching a network that includes the terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a communication system;

FIG. 2 is a diagram illustrating an example of a change in a network connection environment of a terminal;

FIG. 3 is a configuration diagram illustrating an example of the terminal;

FIG. 4 is a configuration diagram illustrating an example of a server;

FIG. 5 is a configuration diagram illustrating an example of functional configurations of the terminal and the server;

FIG. 6 is a diagram illustrating a bundle format;

FIG. 7 is a diagram illustrating examples of delay, disruption tolerant networking (DTN) route tables;

FIG. 8 is a diagram illustrating examples of a connection list, a filter table, and a bundle buffer;

FIG. 9 is a diagram illustrating examples of initial setting files;

FIG. 10 is a diagram illustrating an example of protocol conversion;

FIG. 11 is a flowchart illustrating an example of data transmission processing of an application;

FIG. 12 is a flowchart illustrating an example of bundle transmission processing;

FIG. 13 is a flowchart illustrating an example of bundle reception processing;

FIG. 14 is a flowchart illustrating an example of processing by a route control unit of the terminal;

FIG. 15 is a flowchart illustrating an example of processing by a route control unit of the server;

FIG. 16 is a flowchart illustrating an example of switch processing of the applying of a bundle protocol;

FIG. 17 is a diagram illustrating an example of assignment of endpoint id (EID);

FIG. 18 is a sequence diagram illustrating an example of communication from a control application to an automated driving application;

FIG. 19 is a diagram (#1) illustrating the operation inside the terminal and the server;

FIG. 20 is a diagram (#2) illustrating the operation inside the terminal and the server;

FIG. 21 is a diagram (#3) illustrating the operation inside the terminal and the server;

FIG. 22 is a diagram (#4) illustrating the operation inside the terminal and the server;

FIG. 23 is a diagram (#5) illustrating the operation inside the terminal and the server;

FIG. 24 is a diagram illustrating an example of address notification;

FIG. 25 is a sequence diagram (#1) illustrating another example of communication from the control application to the automated driving application;

FIG. 26 is a sequence diagram (#2) illustrating another example of communication from the control application to the automated driving application; and

FIG. 27 is a diagram illustrating the operation inside the terminal and the server when communicating from a sensor application to a measurement application.

### DESCRIPTION OF EMBODIMENTS

It is impossible with the technique disclosed in Patent Literature 1 to continue communication while dealing with such a change in the network connection environment as described above.

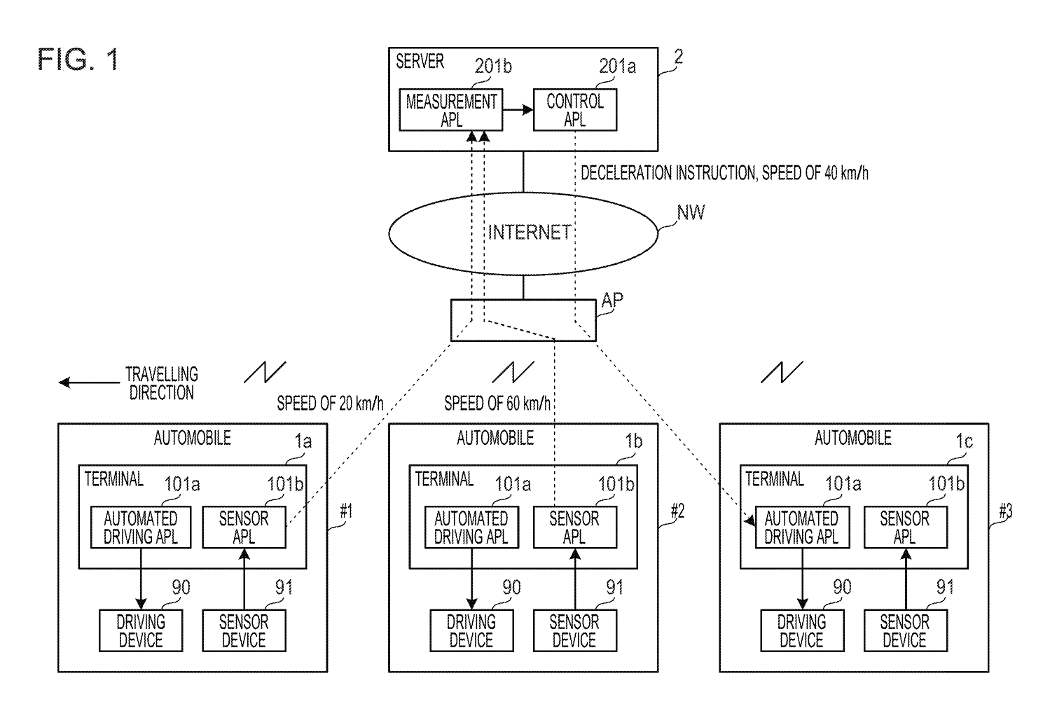

FIG. 1 is a configuration diagram illustrating an example of a communication system. The present embodiment takes a system of mobility internet of things (IoT) service for traffic information as an example of applying the communication system including a server 2 and a plurality of terminals 1a to 1c.

The server 2 is an example of a server device, and is connected to the Internet NW. Operating in the server 2 are a measurement application (measurement APL) 201b for measuring the speed of each of the automobiles #1 to #3 and a control application (control APL) 201a for controlling, based on that speed, the speed of each of the automobiles #1 to #3. The control APL 201a is an example of a first application operating in the server 2.

The terminals 1a to 1c are examples of the terminal device, and are mounted on the automobiles #1 to #3, respectively. The terminals 1a to 1c communicate with the server 2 via the Internet NW by linking with the wireless access point AP connected to the Internet NW. Note that examples of the terminals 1a to 1c include, not limited to, terminal devices for wireless communication such as smartphones. Moreover, the wireless access point AP may correspond to that of a Wi-Fi communication line or may correspond to that of an LTE or 3G communication line.

Operating in the terminals 1a to 1c are sensor applications (sensor APL) 101b for detecting the speeds of the automobiles #1 to #3 using sensor devices 91 mounted on the automobiles #1 to #3, and automated driving applications (automated driving APL) 101a for controlling the driving devices 90 mounted on the automobiles #1 to #3 in accordance with instructions from the server 2. The sensor devices 91 are, for example, sensors for detecting the rotation speeds of the axles of the automobiles #1 to #3, and the driving devices 90 are devices for automatically controlling the speeds and the like of the automobiles #1 to #3 by, for example, accelerators or brakes. Note that the automated driving APL 101a are examples of a second application which operates in the terminal 1.

The sensor APL 101b detect the speeds of the automobiles #1 to #3 using the sensor devices 91 and notify the server 2 via the Internet NW. The measurement APL 201b measures the speeds of the automobiles #1 to #3 in accordance with the notifications from the sensor APL 101b.

The control APL 201a acquires the speeds of the automobiles #1 to #3 from the measurement APL 201b and analyzes the conditions of the roads on which the automobiles #1 to #3 are travelling. Based on the analysis results, the control APL 201a provides speed instructions to the terminals 1a to 1c of the respective automobiles #1 to #3. The automated driving APL 101a control the driving devices 90 so as to have speeds corresponding to the instructions from the control APL 201a.

Thus, the measurement APL 201b establishes a session with the sensor APL 101b, and the control APL 201a establishes a session with the automated driving APL 101a. Hereinafter, a description is provided with reference to an example of speed control.

Assume that each of the automobiles #1 to #3 is travelling on the same road toward the left side of the sheet of FIG. 1 (see the “Traveling Direction”). The sensor APL 101b of the terminal 1a of the automobile #1 detects the speed of the automobile #1 as 20 (km/h) and notifies the server 2. In addition, the sensor APL 101b of the terminal 1b of the automobile #2 detects the speed of the automobile #2 as 60 (km/h) and notifies the server 2.

When receiving the speed of the automobile #1 and the speed of the automobile #2 from the terminals 1a and 1b, the measurement APL 201b of the server 2 outputs the speeds to the control APL 201a. The control APL 201a analyzes the speed of the automobile #1, the speed of the automobile #2, and the like, and instructs the terminal 1c of the automobile #3 to decelerate to a speed of 40 (km/h) based on the analysis results.

According to the instruction of the control APL 201a, the automated driving APL 101a of the terminal 1c of the automobile #3 controls the driving device 90 so that the speed of the automobile #3 becomes 40 (km/h). As a result, the optimum automated driving in accordance with the road conditions is performed on the automobile #3.

However, the terminals 1a to 1c may not continuously link with the wireless access point because the automobiles #1 to #3 are traveling. That is, the link of the terminals 1a to 1c with the wireless access point AP is disconnected when the automobiles #1 to #3 leave the wireless local area network (LAN) coverage area of the wireless access point. For this reason, communication between the server 2 and the terminals 1a to 1c is intermittent.

In addition, the terminals 1a to 1c may again link with the wireless access point AP when the automobiles #1 to #3 enter the wireless LAN coverage area of another wireless access point, and new IP addresses are assigned by DHCP. Therefore, since the server 2 may not know the IP addresses of the terminals 1a to 1c until receiving the communications from the terminals 1a to 1c, the server 2 may not unilaterally provide speed instructions to the terminals 1a to 1c by, for example, push type communication. Hereinafter, the terminal 1c is described as an example.

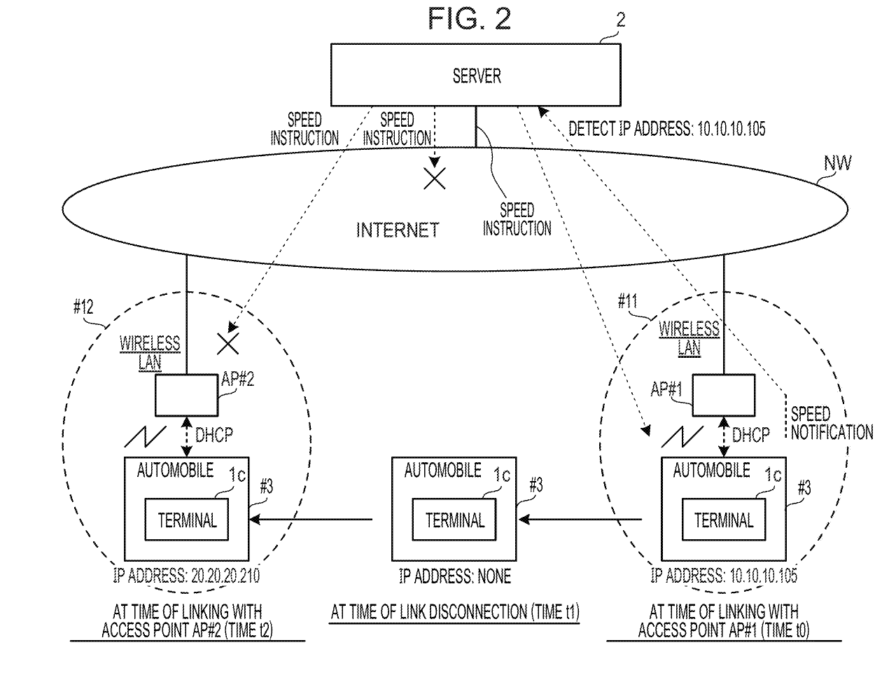

FIG. 2 is a diagram illustrating an example of a change in the network connection environment of the terminal 1c. In FIG. 2, the same reference numerals are given to the configurations common to FIG. 1, and description thereof is omitted.

At time t0, the automobile #3 is traveling in the coverage area of the wireless LAN #11 of the wireless access point AP #1. Here, the terminal 1c is connected to the wireless LAN #11 by linking with the wireless access point AP #1, and assigned the IP address “10.10.10.105” by DHCP communication with the wireless access point AP #1.

The terminal 1c notifies the server 2 of the speed of the automobile #3 via the wireless access point AP #1. The server 2 detects the IP address of the transmission source “10.10.10.105” by receiving the notification on the speed from the terminal 1c. Therefore, the server 2 may provide a speed instruction to the terminal 1c with the IP address “10.10.10.105” as the destination.

Next, at time t1, the automobile #3 leaves the coverage area of the wireless LAN #11. Here, since the terminal 1c is not linked with any wireless access point AP, the server 2 may not provide a speed instruction to the terminal 1c. Note that, since in the link disconnected status, the terminal 1c has no IP address.

Next, at time t2, the automobile #3 enters the coverage area of the wireless LAN #12 of the wireless access point AP #2. Here, the terminal 1c is connected to the wireless LAN #12 by linking with the wireless access point AP #2, and assigned the IP address “20.20.20.210” by DHCP communication with the wireless access point AP #2. As a result, the IP address of the terminal 1c is changed. Note that the wireless LANs #1 and #2 are examples of the network to which the terminal 1c is connected.

Since the server 2 does not know the new IP address of the terminal 1c “20.20.20.210”, the server 2 may not provide a speed instruction to the terminal 1c. Nevertheless, if the terminal 1c notifies the server 2 of the speed again, the server 2 may know the IP address of the terminal 1c “20.20.20.210”. However, in the case of providing a speed instruction after receiving the notification from the terminal 1c, the server 2 may not achieve the control as described with reference to FIG. 1, and it is impossible to effectively allow the system to function.

In light of the above, the server 2 and the terminals 1a to 1c have a configuration for allowing the applications 101a, 101b, 201a, and 201b to communicate based on the technology of disruption tolerant network. In addition, the terminals 1a to 1c notify the server 2 of IP addresses each time IP addresses are assigned. As a result, the server 2 and the terminals 1a to 1c are capable of smooth communication even in an environment where communication is intermittent due to the change in the network connection environment of the terminals 1a to 1c. The configuration of the terminals 1a to 1c and the server 2 is described.

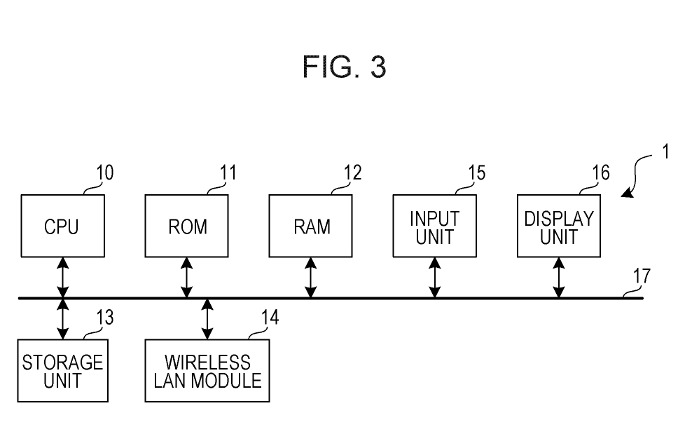

FIG. 3 is a configuration diagram illustrating an example of the terminals 1a to 1c. Note that in the following description, the terminals 1a to 1c are representatively denoted as “terminal 1”.

The terminal 1 includes a central processing unit (CPU) 10, a read only memory (ROM) 11, a random access memory (RAM) 12, a storage unit 13 such as a hard disk drive (HDD) or a memory, a wireless LAN module 14, an input unit 15, and a display unit 16. The CPU 10 is connected to the ROM 11, the RAM 12, the storage unit 13, the wireless LAN module 14, the input unit 15, and the display unit 16 via a bus 17 so as to enable mutual inputting/outputting of signals.

The ROM 11 has a program for driving the CPU 10 stored therein. The program in the ROM 11 includes an operating system (OS) and a communication program for executing the communication method of the embodiment. As described later, this communication method processes communication between the applications 201a and 201b operating in the server 2 and the applications 101a and 101b operating in the terminal 1.

The RAM 12 functions as a working memory of the CPU 10. The storage unit 13 stores various kinds of information used for executing the program. The wireless LAN module 14 communicates with the server 2 on the Internet NW by linking with the wireless access point AP.

The input unit 15 is a means for inputting information to the terminal 1. Examples of the input unit 15 include keyboards, mice, and touch panels. The input unit 15 outputs the inputted information to the CPU 10 via the bus 17.

The display unit 16 is a means for outputting the information on the terminal 1. Examples of the display unit 16 include displays, touch panels, and printers. The display unit 16 acquires information from the CPU 10 via the bus 17 for display. For example, the display unit 16 displays the communication status and results of the applications 101a and 101b of the terminal 1.

When reading the program from the ROM 11, the CPU 10 forms various functions for executing the communication method. The CPU 10 is an example of a computer which executes programs. Note that the functional configuration of the terminal 1 is described later.

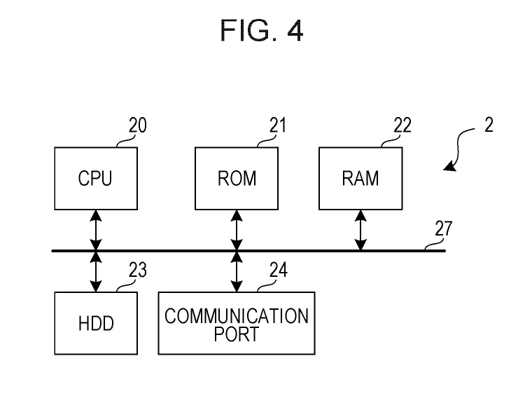

FIG. 4 is a configuration diagram illustrating an example of the server 2. The server 2 has a CPU 20, a ROM 21, a RAM 22, an HDD 23, and a communication port 24. The CPU 20 is connected to the ROM 21, the RAM 22, the HDD 23, and the communication port 24 via a bus 27 so as to enable mutual inputting/outputting of signals.

The ROM 21 has a program for driving the CPU 20 stored therein. The program in the ROM 21 includes an operating system (OS) and a communication program for executing the communication method of the embodiment. As described later, this communication method processes communication between the applications 201a and 201b operating in the server 2 and the applications 101a and 101b operating in the terminal 1. The RAM 22 functions as a working memory of the CPU 20. The communication port 24 is, for example, a network interface card (NIC) and communicates with the terminal 1 via the Internet NW.

When reading the program from the ROM 21, the CPU 20 forms various functions for executing the communication method. The CPU 20 is an example of a computer which executes programs.

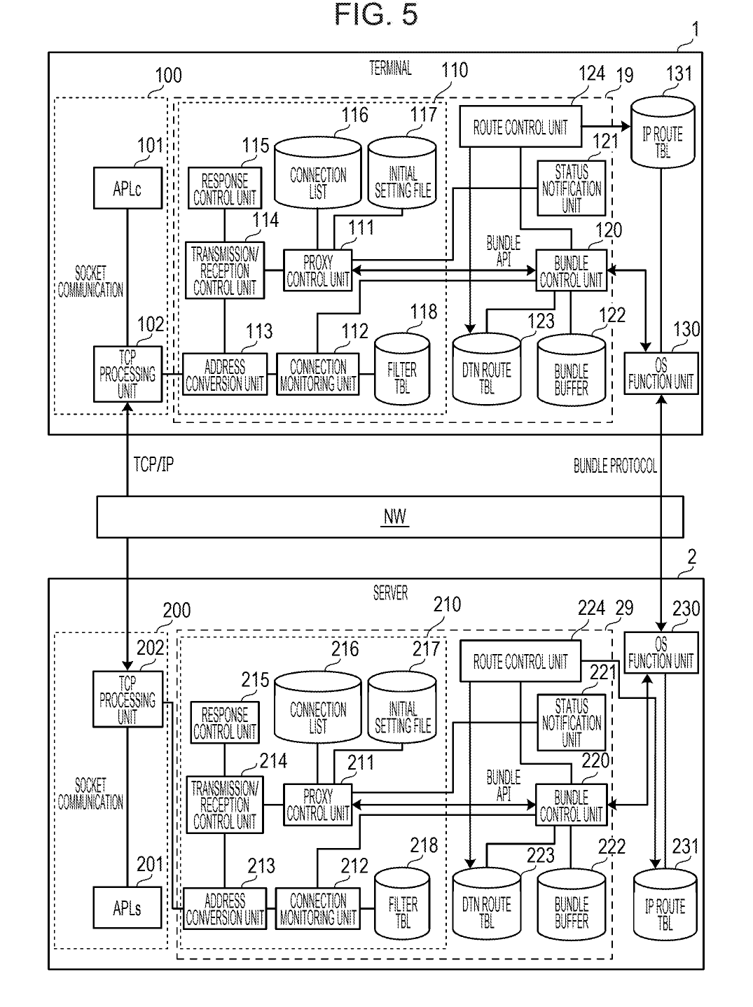

FIG. 5 is a configuration diagram illustrating an example of functional configurations of the terminal 1 and the server 2. The terminal 1 and the server 2 are connected via the Internet NW as an example.

The terminal 1 includes an application function unit 100, a DTN proxy unit 19, an OS function unit 130, and an IP route table (IP route TBL) 131. The DTN proxy unit 19 includes a proxy protocol function unit 110, a bundle control unit 120, a status notification unit 121, a bundle buffer 122, a DTN route table (DTN route TBL) 123, and a route control unit 124. Note that the DTN proxy unit 19 is an example of the first proxy unit.

The application function unit 100 includes an application (APLc) 101 and a TCP processing unit 102. The application 101 corresponds to the sensor APL 101b and the automated driving APL 101a of the terminals 1a to 1c.

The proxy protocol function unit 110 includes a proxy control unit 111, a connection monitoring unit 112, an address conversion unit 113, a transmission/reception control unit 114, a response control unit 115, a connection list 116, an initial setting file 117, and a filter table (filter TBL) 118. The proxy protocol function unit 110 conceals the difference in the transport protocol between the layers from the bundle control unit 120 by mediating between the application layer where the application 101 functions and the bundle layer where the bundle control unit 120 functions. The proxy protocol function unit 110 is individually generated for each of the automated driving APL 101a and the sensor APL 101b.

The application 101, the TCP processing unit 102, the proxy control unit 111, the connection monitoring unit 112, the address conversion unit 113, the transmission/reception control unit 114, the response control unit 115, the bundle control unit 120, the status notification unit 121, the route control unit 124, and the OS function unit 130 are functions formed by the CPU 10 of the terminal 1. In addition, the connection list 116, the initial setting file 117, the filter TBL 118, the bundle buffer 122, the DTN route TBL 123, and the IP route TBL 131 are stored in the storage unit 13.

On the other hand, the server 2 includes an application function unit 200, a DTN proxy unit 29, an OS function unit 230, and an IP route TBL 231. The DTN proxy unit 29 includes a proxy protocol function unit 210, a bundle control unit 220, a status notification unit 221, a bundle buffer 222, a DTN route TBL 223, and a route control unit 224. Note that the DTN proxy unit 29 is an example of the second proxy unit.

The application function unit 200 includes an application (APLs) 201 and a TCP processing unit 202. The application 201 corresponds to the control APL 201a and the measurement APL 201b.

The proxy protocol function unit 210 includes a proxy control unit 211, a connection monitoring unit 212, an address conversion unit 213, a transmission/reception control unit 214, a response control unit 215, a connection list 216, an initial setting file 217, and a filter TBL 218. The proxy protocol function unit 210 conceals the difference in the transport protocol between the layers from the bundle control unit 220 by mediating between the application layer where the application 201 functions and the bundle layer where the bundle control unit 220 functions. The proxy protocol function unit 210 is individually generated for the measurement APL 201b and each of the terminals 1a to 1c as the communication destination of the control APL 201a.

The application 201, the TCP processing unit 202, the proxy control unit 211, the connection monitoring unit 212, the address conversion unit 213, the transmission/reception control unit 214, the response control unit 215, the bundle control unit 220, the status notification unit 221, the route control unit 224, and the OS function unit 230 are functions formed by the CPU 20 of the server 2. In addition, the connection list 216, the initial setting file 217, the filter TBL 218, the bundle buffer 222, the DTN route TBL 223, and the IP route TBL 231 are stored in the HDD 23.

The application 201 and the application 101 communicate with each other by the TCP processing units 102 and 202 to provide predetermined functions. Examples of the functions of the application 201 and the application 101 include, but not limited to, the functions described with reference to FIG. 1.

The TCP processing units 102 and 202 have a function of TCP/IP communication provided by a driver of the OS, for example. The TCP processing unit 102 of the terminal 1 controls the wireless LAN module 14 to transmit and receive packets, and the TCP processing unit 202 of the server 2 controls the communication port 24 to transmit and receive packets.

The application 201 and the application 101 directly perform communication based on TCP/IP via the Internet NW. However, in an environment in which the communication is intermittent, the bundle control units 120 and 220 perform communication based on the bundle protocol of DTN instead of communication based on TCP/IP. When the communication is disrupted, the bundle control units 120 and 220 bundle the data to be transmitted by the applications 101 and 201 for temporary storage in the bundle buffers 122 and 222. When the communication is enabled, the bundle control units 120 and 220 read the bundle data from the bundle buffers 122 and 222 for transmission to the communication destination (the server 2 or the terminal 1).

The bundle control unit 120 performs communication from the application 101 to the communication destination by switching from communication based on TCP/IP to communication based on the bundle protocol of DTN depending on the connection status with the communication destination. Here, the connection monitoring unit 112 monitors the connection status with the communication destination, and controls the address conversion unit 113 depending on the connection status.

As a result, the connection monitoring unit 112 switches the communication of the application 101 with the communication destination from the communication by TCP/IP to the communication based on the bundle protocol of DTN. Therefore, the communication of the application 101 is switched from the communication based on TCP/IP by the TCP processing unit 102 to the communication based on bundle protocol by the bundle control unit 120.

In addition, the bundle control unit 220 performs communication from the application 201 to the communication destination by switching from communication based on TCP/IP to communication based on the bundle protocol of DTN depending on the connection status with the communication destination. Here, the connection monitoring unit 212 monitors the connection status with the communication destination, and controls the address conversion unit 213 depending on the connection status.

As a result, the connection monitoring unit 212 switches the communication of the application 201 with the communication destination from the communication by TCP/IP to the communication based on the bundle protocol of DTN. Therefore, the communication of the application 201 is switched from the communication based on TCP/IP by the TCP processing unit 202 to the communication based on bundle protocol by the bundle control unit 220.

The bundle control units 120 and 220 perform communication based on the bundle protocol in accordance with, for example, the rules of request for comments (RFC) 5050. The bundle control units 120 and 220 accommodate transmission target data of the applications 101 and 201 in a payload portion of a data message called a bundle, and transmit the transmission target data.

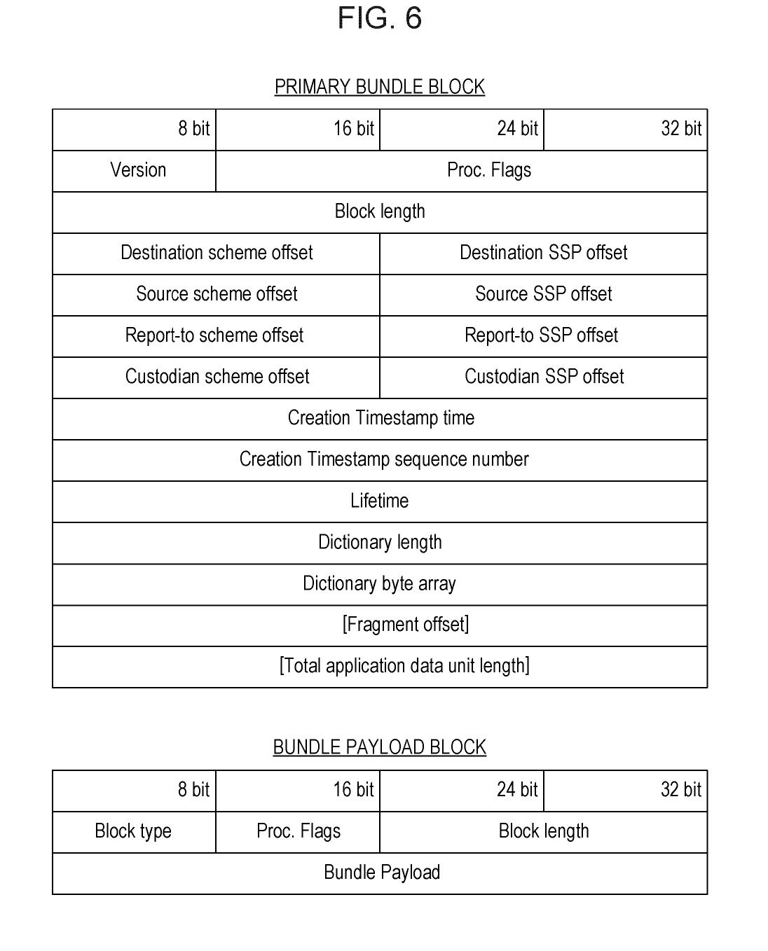

FIG. 6 illustrates the bundle format. The bundle includes a primary bundle block and a bundle payload block. The primary bundle block includes information on the transmission source and destination, the lifetime (“Lifetime”) indicating the time until bundle deletion, and the like. The bundle payload block includes a payload (“Bundle Payload”) for accommodating data. Note that each of the items in the bundle is specified in RFC 5050.

Reference again to FIG. 5 reveals that, when transmitting a bundle, the bundle control units 120 and 220 refer to the DTN route TBLs 123 and 223 to acquire the destination IP address and the TCP port number (hereinafter referred to as the “port number”) on the TCP/IP corresponding to the EID indicating the destination in the bundle protocol.

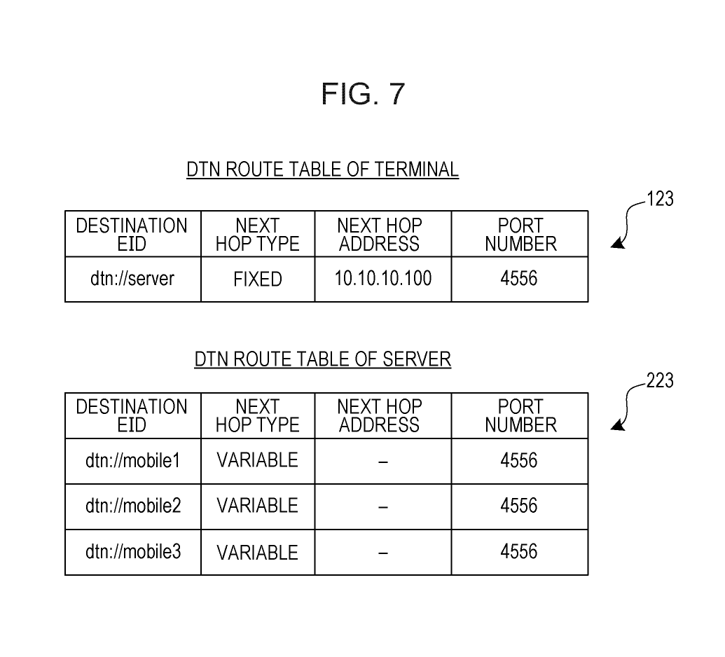

FIG. 7 is a diagram illustrating examples of the DTN route TBLs 123 and 223. In the DTN route TBLs 123 and 223, destination EIDs, next hop types which are the types of destination IP address, next hop addresses which are destination IP addresses, and destination port numbers are registered.

In the DTN route TBL 123 of the terminal 1, the EID of the server 2 “dtn://server” is registered in the destination EID. In addition, since the IP address of the server 2 is fixed, “Fixed” is registered in Next Hop Type. Further, based on the initial setting file 117, the IP address of the server 2 “10.10.10.100” is registered in Next Hop Address, and “4556” is registered in the port number.

On the other hand, in the DTN route TBL 223 of the server 2, the EIDs of the terminals 1 (that is, the terminals 1a to 1c) “dtn://mobile1”, “dtn://mobile2”, and “dtn://mobile3” are registered in the destination EID. In addition, since the IP addresses of the terminals 1 are variable with the wireless LAN of the connection destinations of the terminals 1, “Variable” is registered in Next Hop Type, and Next Hop Address is unregistered (“−”). As described later, the next hop addresses are registered based on the address notifications received from the terminals 1. In addition, “4556” is registered as the port numbers based on the initial setting file 217.

Reference again to FIG. 5 reveals that, when the connection with the destination, that is, the connection between the terminal 1 and the server 2 is disconnected, the bundle control units 120 and 220 store bundles in the bundle buffers 122 and 222, and read and transmit the bundles from the bundle buffers 122 and 222 when the connection is reconnected. This causes communication based on the DTN.

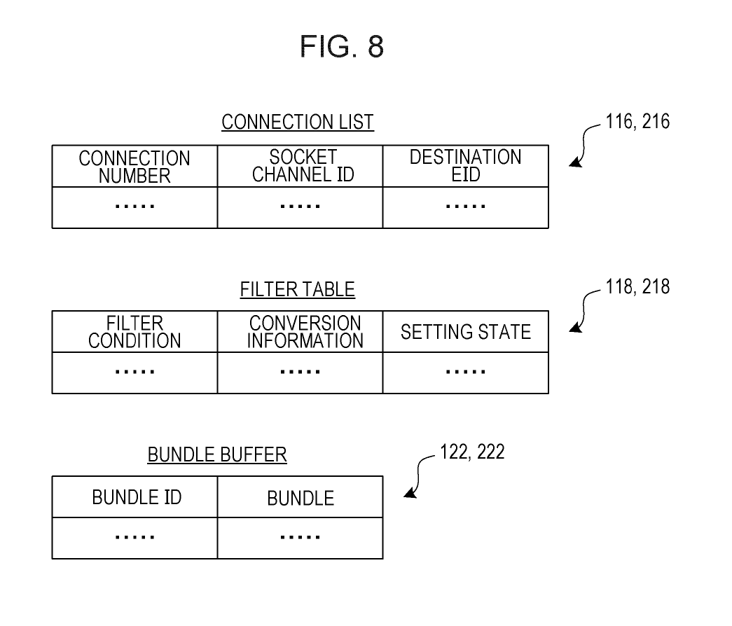

FIG. 8 illustrates an example of the bundle buffers 122 and 222. The bundle buffers 122 and 222 are bundle storage areas. Bundles are stored in the bundle buffers 122 and 222 together with the bundle IDs identifying the bundles. Note that the bundle control units 120 and 220 store bundles in the bundle buffers 122 and 222 not only when transmitting bundles but also when receiving bundles.

Reference again to FIG. 5 reveals that the bundle control units 120 and 220 transmit and receive bundles by the OS function units 130 and 230 included in the OS. The OS function unit 130 of the terminal 1 includes a communication processing function by the wireless LAN module 14 and processes link and communication with the wireless access point AP. In addition, the OS function unit 230 of the server 2 includes a communication processing function by the communication port 24 and processes link and communication with the device of the connection destination of the communication port 24. The OS function units 130 and 230 search the IP route TBLs 131 and 231 for a gateway address corresponding to the IP address of the communication destination and communicate by accessing the gateway address.

The route control unit 124 of the terminal 1 generates a communication route corresponding to the session established by the communication between the application 101 and the application 201. More specifically, the route control unit 124 monitors the OS function unit 130, and when detecting the assignment of a new IP address by DHCP as a result of monitoring, the route control unit 124 sets the gateway address corresponding to the IP address in the IP route TBL 131. In addition, the route control unit 124 generates an address notification including the IP address and transmits the address notification to the route control unit 224 of the server 2 via the bundle control unit 120. Here, prior to the transmission, the route control unit 124 opens a socket for communicating from the bundle control unit 120 to the bundle control unit 220 of the server 2.

The route control unit 224 of the server 2 generates a communication route corresponding to the session established by the communication between the application 101 and the application 201. More specifically, when receiving the address notification from the route control unit 124 of the terminal 1, the route control unit 224 acquires the IP address of the terminal 1 from the address notification and registers the IP address in the next hop address of the DTN route TBL 223. In addition, the route control unit 224 opens a socket for communicating from the bundle control unit 220 to the bundle control unit 120 of the terminal 1, and generates and transmits an address notification including the IP address of the server 2 as a response to the route control unit 124.

This makes it possible to communicate between the application 101 and the application 201 even when the wireless LAN of the connection destination of the terminal 1 is switched, and the session between the application 101 and the application 201 is maintained.

The proxy protocol function units 110 and 210 convert the communication between the application 101 and the application 201 from TCP socket communication to bundle protocol communication. Here, the proxy protocol function units 110 and 210 set and control the bundle control units 120 and 220 in accordance with a bundle application programming interface (API), thereby making DTN available even in common applications. Hereinafter, the details of the proxy protocol function units 110 and 210 are described.

The address conversion units 113 and 213 convert the communication destinations of the applications 101 and 201 to the destinations of the transmission/reception control units 114 and 214. In the terminal 1, for example, the address conversion unit 113 converts the destination IP address and the port number of a packet having the server 2 as the destination to the destination IP address and the port number of the TCP socket (hereinafter referred to as the “socket”) set in the transmission/reception control unit 114.

For this reason, the proxy protocol function units 110 and 210 may receive the data of packets transmitted from the applications 101 and 201 to the communication destinations. Note that the address conversion units 113 and 213 are embodied by windows filtering platform (WFP) when Windows (registered trademark, hereinafter the same) is used as the OS, and embodied by “iptables” when Linux is used as the OS, for example.

The transmission/reception control units 114 and 214 terminate the TCP socket communication of the applications 101 and 201. The transmission/reception control units 114 and 214 establish a local loopback connection in the device.

The transmission/reception control unit 114 of the terminal 1 monitors the connection of the socket (that is, opening of the socket) from the application 101, and obeys the instructions from the proxy control unit 111 to establish a session for the application 201 of the server 2 and transmit data to the designated socket. In addition, the transmission/reception control unit 214 of the server 2 monitors the connection of the socket from the application 201, and obeys the instructions from the proxy control unit 211 to establish a session for the application 101 of the terminal 1 and transmit data to the designated socket. The transmission/reception control unit 114 notifies the applications 101 and 201 of the establishment of a session with the communication destination.

The proxy control units 111 and 211 accommodate the data of the packets received by the transmission/reception control units 114 and 214 in the payload of proxy message and output the data to the bundle control units 120 and 220 with the bundle API. As a result, the bundle transmission is requested from the proxy control units 111 and 211 to the bundle control units 120 and 220.

The proxy control units 111 and 211 manage proxy messages with connection numbers corresponding to the destinations. Each time the socket is opened by the transmission/reception control units 114 and 214, the proxy control units 111 and 211 register a new connection number in the connection lists 116 and 216.

FIG. 8 illustrates an example of the connection lists 116 and 216. In the connection lists 116 and 216, the connection number, the socket channel ID, and the destination EID are registered in association with one another. The socket channel ID is an identifier of the socket of the transmission/reception control units 114 and 214.

The proxy control units 111 and 211 give the proxy message a connection number corresponding to the socket channel ID of the socket of the packet reception source for output to the bundle control units 120 and 220. In addition, the proxy control units 111 and 211 request the bundle control units 120 and 220 for bundle transmission to the corresponding destination EID.

Thus, the EID of the server 2 is registered in the destination EID of the connection list 116 of the terminal 1, and the EID of the terminal 1 is registered in the destination EID of the connection list 216 of the server 2. Also, the proxy control units 111 and 211 read the initial setting files 117 and 217 to acquire information indispensable for communication such as the EIDs of the own devices and the EIDs of the communication destinations.

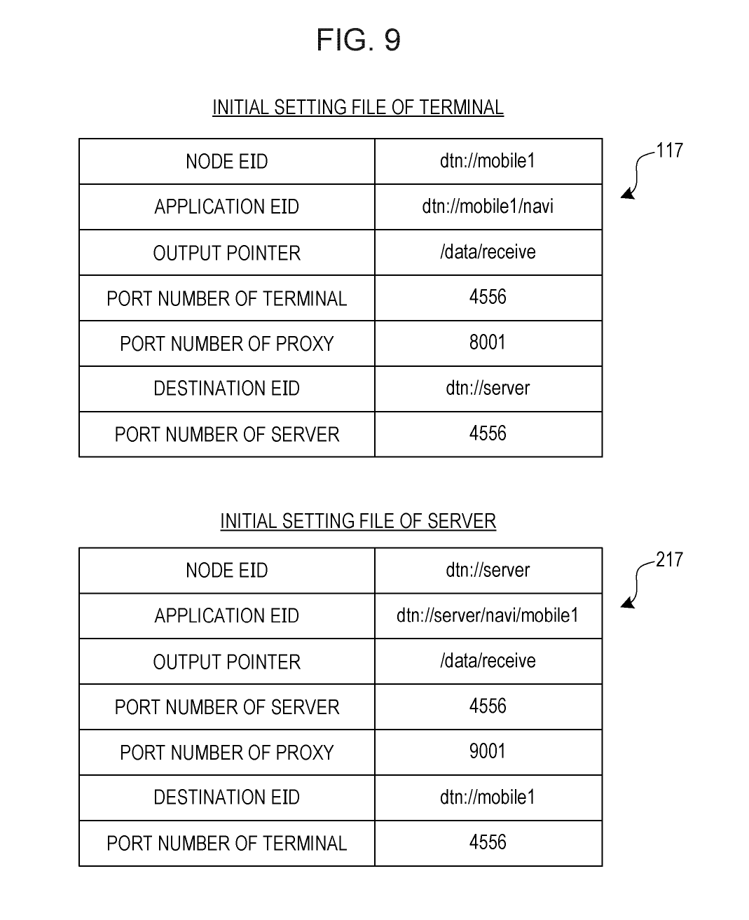

FIG. 9 is a diagram illustrating examples of the initial setting files 117 and 217. This example illustrates the initial setting file 117 of the proxy control unit 111 corresponding to the automated driving APL 101a and the initial setting file 217 of the control APL 201a having the terminal 1a as the communication destination. In the initial setting files 117 and 217, node EIDs, application EIDs, output pointers, various port numbers, and destination EIDs are registered.

The node EID is an EID for identifying a communication node and is associated with an IP address. The node EIDs of the terminals 1a to 1c are assumed to be, as an example, “dtn://mobile1”, “dtn://mobile2”, and “dtn://mobile3”, respectively. In addition, the node EID of the server 2 is assumed to be “dtn://server” as an example.

The application EID is an EID for identifying the applications 101 and 201 and is associated with the proxy control units 111 and 211. For example, the application EID of the automated driving APL 101a of the terminal 1 is “dtn://mobile1/navi” and the application EID of the control APL 201a for the terminal 1a of the server 2 is “dtn://server/navi/mobile1”.

The output pointer indicates the directory of the output destination of the bundle received by the bundle control units 120 and 220. The port number of the terminal 1 is the port number of the socket for the bundle control unit 120 to transmit and receive bundles, and the port number of the server 2 is the port number corresponding to the socket for the bundle control unit 220 to transmit and receive bundles. In addition, the proxy port number is a port number corresponding to the socket for the proxy control units 111 and 211 to transmit and receive data to and from the applications 101 and 201.

Reference again to FIG. 5 reveals that the proxy control units 111 and 211 receive proxy messages from the bundle control units 120 and 220. When the connection number of a received proxy message is unregistered in the connection lists 116 and 216, the proxy control units 111 and 211 instruct the transmission/reception control units 114 and 214 to open a new socket to start a session by the socket.

In addition, when data is not accommodated in the received proxy message, the proxy control units 111 and 211 search the connection list 116 for the socket channel ID corresponding to its connection number. The proxy control units 111 and 211 determine that the communication has ended, and instruct the transmission/reception control units 114 and 214 to delete the socket of the searched socket channel ID.

As described above, the socket and the EID are managed in association with each other by the connection list 116. This makes it possible to perform TCP/IP communication using a socket based on bundle protocol.

In addition, the bundle control units 120 and 220 transmit bundles in response to the bundle transmission request from the proxy control units 111 and 211. Thus, the bundle control units 120 and 220 may perform communication from the applications 101 and 201 to the communication destination based on the protocol of the disruption tolerant network.

When the communication from the applications 101 and 201 requires a response, the response control units 115 and 215 generate that response and output the response to the applications 101 and 201. For this reason, the applications 101 and 201 operate without knowing communication disruption even when the communication with the communication destination is disrupted due to the disconnection of the connection. Therefore, it is unnecessary to redo communication after the reconnection of the connection.

For example, when the proxy control unit 111 performs communication of the application 101 in the terminal 1, the response control unit 115 outputs a response to that communication to the application 101. In the case of dividing a file and forwarding the file from the application 101 to the application 201, the response control unit 115 of the terminal 1 urges the application 101 to transmit the next file data as a response instead of the application 201.

Specifically, the response control units 115 and 215 notify the applications 101 and 201 of the completion of communication. As a result, the applications 101 and 201 recognize that the communication has succeeded, not knowing the results of the communication based on the bundle protocol of the bundle control units 120 and 220.

As a result, the status notification units 121 and 221 notify the user of the communication information on the status and the results of communication by use of, for example, a pop-up display or a log on the screen. More specifically, the status notification unit 121 of the terminal 1 outputs communication information to the display unit 16, or writes in the storage unit 13 a log file having records of the communication information. In addition, the status notification unit 221 of the server 2 writes in the HDD 23 a log file having records of the communication information.

The proxy control units 111 and 211 instruct the status notification units 121 and 221 to provide a notification based on the communication status. Consequently, the status notification units 121 and 221 notify the user of a communication failure when the proxy control units 111 and 211 determine that the communication has failed.

The connection monitoring units 112 and 212 monitor the connection status of the bundle control units 120 and 220. The connection monitoring units 112 and 212 establish connection while the connection is disconnected and, if the connection has succeeded, instruct the connection monitoring units 112 and 212 to transmit the transmission target bundle in the bundle buffers 122 and 222.

In addition, the connection monitoring units 112 and 212 set and delete the conversion information for the address conversion units 113 and 213 depending on the connection status. The connection monitoring units 112 and 212 set the conversion information based on the filter TBLs 118 and 218.

FIG. 8 illustrates an example of the filter TBLs 118 and 218. The filter condition, the conversion information, and the setting state of the packet are registered in the filter TBLs 118 and 218 in association with one another. The filter condition designates the IP address, the port number, and the like of the transmission source and destination of the packet for address conversion. The conversion information indicates the rewriting target section and the rewritten value of the packet which matches the filter condition. The setting state indicates validity or invalidity of settings of the filter condition and the conversion information.

Reference again to FIG. 5 reveals that the connection monitoring units 112 and 212 set or delete the conversion information of the address conversion units 113 and 213 depending on the connection status. For this reason, the bundle protocol is automatically applied to the communication of the applications 101 and 201.

As described above, the connection monitoring units 112 and 212 detect the connection status with the communication destination, and decide depending on the connection status whether to apply the bundle protocol to the communication of the applications 101 and 201. Thus, the bundle protocol is used for the communication of the applications 101 and 201 depending on the connection status.

When the communication is intermittent, the applications 101 and 201 communicate by TCP/IP protocol conversion using the above configuration.

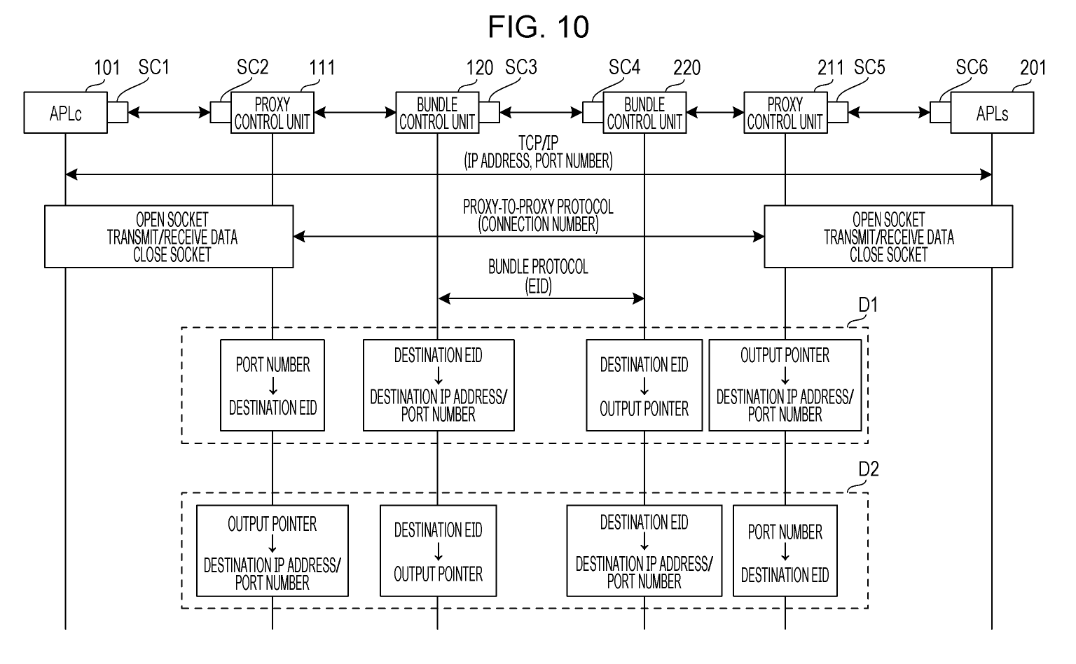

FIG. 10 illustrates an example of the protocol conversion. Among the configurations illustrated in FIG. 5, FIG. 10 illustrates the application 101, the proxy control unit 111, and the bundle control unit 120 of the terminal 1 as well as the application 201, the proxy control unit 211, and the bundle control unit 220 of the server 2.

TCP/IP communication using an IP address and a port number is performed between the application 101 and the application 201. A socket SC1 is opened in the application 101 of the terminal 1, and a socket SC6 is opened in the application 201 of the server 2. As described above, the application 101 and the application 201 communicate with each other to establish a session.

Communication by the proxy-to-proxy protocol based on a connection number is performed between the proxy control units 111 and 211. The transmission/reception control unit 114 opens a socket SC2 in one-to-one correspondence to the socket SC6 of the application 201 in the proxy control unit 111. Thereby, the proxy control unit 111 establishes a session with the application 101.

In addition, the transmission/reception control unit 214 opens a socket SC5 in one-to-one correspondence to the socket SC1 of the application 101 in the proxy control unit 211. Thereby, the proxy control unit 211 establishes a session with the application 201.

Communication by the sockets SC1 and SC2 is performed between the application 101 and the proxy control unit 111, and communication by the sockets SC5 and SC6 is performed between the application 201 and the proxy control unit 211. Thus, the transmission/reception control units 114 and 214 open and close the sockets SC2 and SC5 in conjunction with the sockets SC1 and SC6 of the application 101 and the application 201, respectively, and perform data transmission/reception by the sockets SC2 and SC5. Note that each of the sockets SC1, SC2, SC5, and SC6 is closed at the end of a session.

Bundle protocol communication by EID is performed between the bundle control units 120 and 220. The route control units 124 and 224 open the sockets SC3 and SC4 in the bundle control units 120 and 220, respectively. When a new IP address is assigned to the terminal 1, the route control unit 124 opens the socket SC3 in the bundle control unit 120. Consequently, the route control unit 124 transmits the address notification on the IP address to the route control unit 224 of the server 2.

In addition, when receiving an address notification, the route control unit 224 opens a socket SC4 in the bundle control unit 220. Consequently, the route control unit 224 transmits the address notification on the IP address to the route control unit 124 of the terminal 1.

In the case of communication from the application 101 of the terminal 1 to the application 201 of the server 2, the proxy control unit 111 in the terminal 1 converts the port number of the packet to a destination EID based on the initial setting file 117 as denoted by the reference numeral D1. In addition, the bundle control unit 120 converts the destination EID to a destination IP address and a port number based on the DTN route TBL 123.

In addition, the bundle control unit 220 in the server 2 converts the destination EID to an output pointer, and the proxy control unit 211 converts the output pointer to a destination IP address and a port number. As described above, communication from the application 101 of the terminal 1 to the application 201 of the server 2 is performed.

On the other hand, in the case of communication from the application 201 of the server 2 to the application 101 of the terminal 1, the proxy control unit 211 in the server 2 converts the port number of the packet to a destination EID based on the initial setting file 217 as denoted by the reference numeral D2. In addition, the bundle control unit 220 converts the destination EID to a destination IP address and a port number based on the DTN route TBL 223.

In addition, the bundle control unit 120 in the terminal 1 converts the destination EID to an output pointer, and the proxy control unit 111 converts the output pointer to a destination IP address and a port number. As described above, communication from the application 201 of the server 2 to the application 101 of the terminal 1 is performed. Hereinafter, processing to be executed in the communication between the applications 101 and 201 is described.

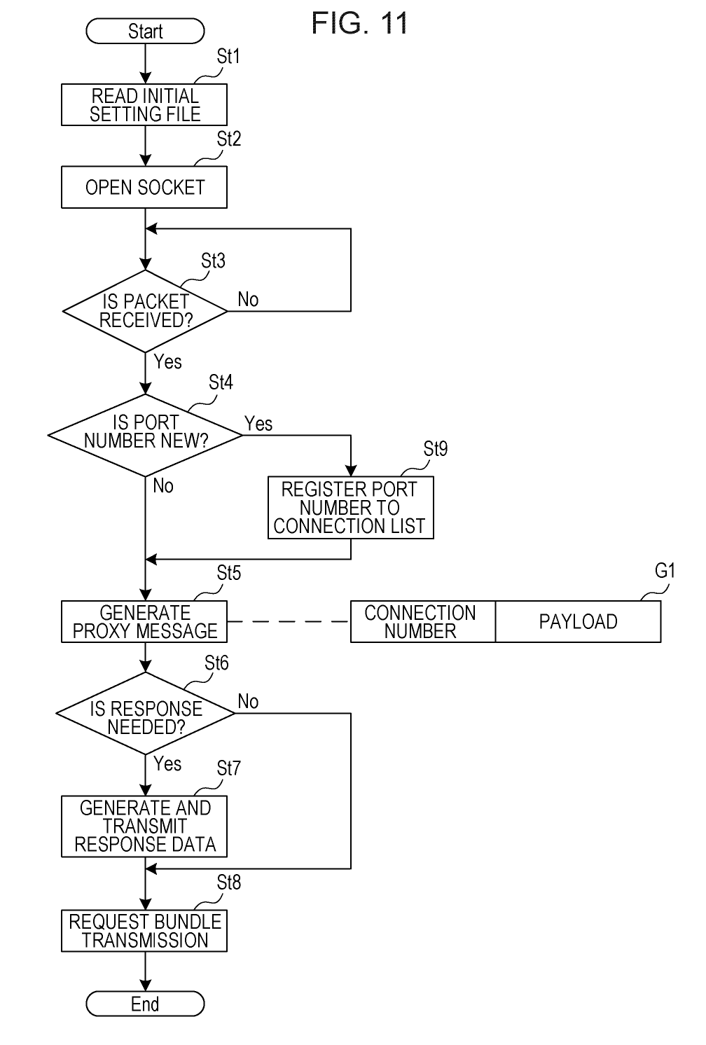

FIG. 11 is a flowchart illustrating an example of data transmission processing of the applications 101 and 201. The proxy control units 111 and 211 read the initial setting files 117 and 217 (operation St1).

The proxy control units 111 and 211 open sockets for receiving packets addressed to the applications 201 and 101 of the communication destinations from the applications 101 and 201 to the transmission/reception control units 114 and 214 (operation St2). Set in the sockets is the loopback IP address “127.0.0.1” or the proxy port numbers of the initial setting files 117 and 217.

Thus, the application 101 of the terminal 1 transmits a packet to the socket generated by the transmission/reception control unit 114 instead of the socket of the application 201 of the server 2. In addition, the application 201 of the server 2 transmits a packet to the socket generated by the transmission/reception control unit 214 instead of the socket of the application 101 of the terminal 1. Here, the destination IP address and the port number of the packet are converted by predetermined settings or the address conversion units 113 and 213.

The transmission/reception control units 114 and 214 determine whether or not a packet has been received in the socket (operation St3). If no packet has been received (No in operation St3), the transmission/reception control units 114 and 214 execute again the determination processing in operation St3.

If a packet has been received (Yes in operation St3), the proxy control units 111 and 211 determine whether or not the transmission source port number of the packet is new (operation St4). Specifically, the proxy control units 111 and 211 determine whether or not the port numbers of the applications 101 and 201 have been changed to establish a new channel. Note that when the sockets receive packets, the transmission/reception control units 114 and 214 detect the completion of communication from the applications 101 and 201, and output the data of the received packets to the proxy control units 111 and 211 via a memory or the like. Here, the transmission/reception control units 114 and 214 notify the applications 101 and 201 of the establishment of a session.

If the transmission source port number is new (Yes in operation St4), the proxy control units 111 and 211 register a new connection number as well as the socket channel ID and the destination EID corresponding to that connection number in the connection lists 116 and 216 (operation St9). In addition, if the transmission source port number is not new (No in operation St4), the proxy control units 111 and 211 do not execute the processing of operation St9.

The proxy control units 111 and 211 generate the proxy message denoted by the reference numeral G1 (operation St5). The proxy message includes a connection number and a payload. The proxy control units 111 and 211 generate proxy messages by accommodating packet data in the payload and giving the connection numbers retrieved from the connection lists 116 and 216. The proxy messages are outputted to the bundle control units 120 and 220 with the bundle API.

The response control units 115 and 215 determine the necessity of a response for the packet to be transmitted (operation St6). The response control units 115 and 215 determine the necessity of a response for continuing communication at the application level, not ACK of TCP.

If a response is indispensable (Yes in operation St6), the response control units 115 and 215 generate response data instead of the applications 201 and 101 being the communication destinations based on a predetermined algorithm, and transmit the response data to the applications 101 and 201 (operation St7). Specifically, the response control units 115 and 215 notify the application 101 and the application 201 of the completion of communication. Therefore, as described above, the applications 101 and 201 recognize that the communication has succeeded even if the bundle protocol communication fails. In addition, if a response is unnecessary (No in operation St6), the response control units 115 and 215 do not generate response data.

The proxy control units 111 and 211 request the bundle control units 120 and 220 for bundle transmission with the bundle API (operation St8). The bundle control units 120 and 220 generate a bundle from the proxy message for transmission. Consequently, the bundle control units 120 and 220 perform communication from the applications 101 and 201 to the applications 201 and 101 being the communication destinations based on the protocol of the disruption tolerant network. As described above, the data transmission processing of the applications 101 and 201 is executed.

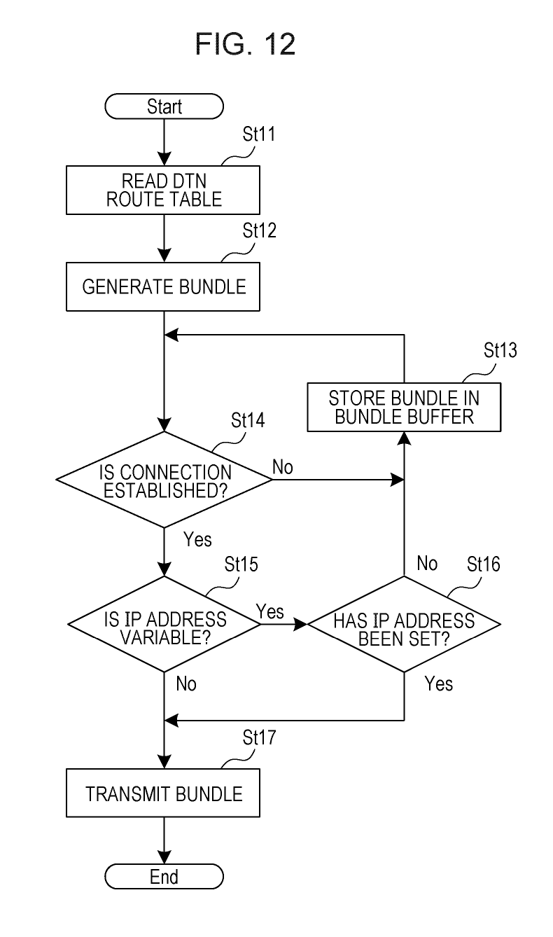

FIG. 12 is a flowchart illustrating an example of bundle transmission processing. When requested for bundle transmission by the proxy control units 111 and 211, the bundle control units 120 and 220 read the DTN route TBLs 123 and 223 (operation St11). Based on the DTN route TBLs 123 and 223, the bundle control units 120 and 220 generate bundles for the destination IP address and the port number corresponding to the destination EID (operation St12).

The bundle control units 120 and 220 determine whether or not the connection with the communication destination corresponding to the destination EID has been established (operation St14). If the connection is not established (No in operation St14), the bundle control units 120 and 220 store the bundle in the bundle buffers 122 and 222 (operation St13) and execute the processing of operation St14 again.

If the connection has been established (Yes in operation St14), the bundle control units 120 and 220 determine whether or not the IP address is variable based on the next hop type of the DTN route TBLs 123 and 223 (operation St15). If the IP address is fixed (No in operation St15), the bundle control units 120 and 220 transmit the bundle (operation St17).

In addition, if the IP address is variable (Yes in operation St15), the bundle control units 120 and 220 determine whether or not the IP address has been set based on the next hop address of the DTN route TBLs 123 and 223 (operation St16). If the IP address is not set (No in operation St16), the bundle control units 120 and 220 store the bundle in the bundle buffers 122 and 222 (operation St13) and execute the process of operation St14 again. Note that if the IP address is not set, the bundle is generated with a temporary IP address, and the IP address is corrected after the IP address is set, for example.

In addition, if the IP address has been set (Yes in operation St16), the bundle control units 120 and 220 transmit the bundle (operation St17). As described above, the bundle transmission processing is executed.

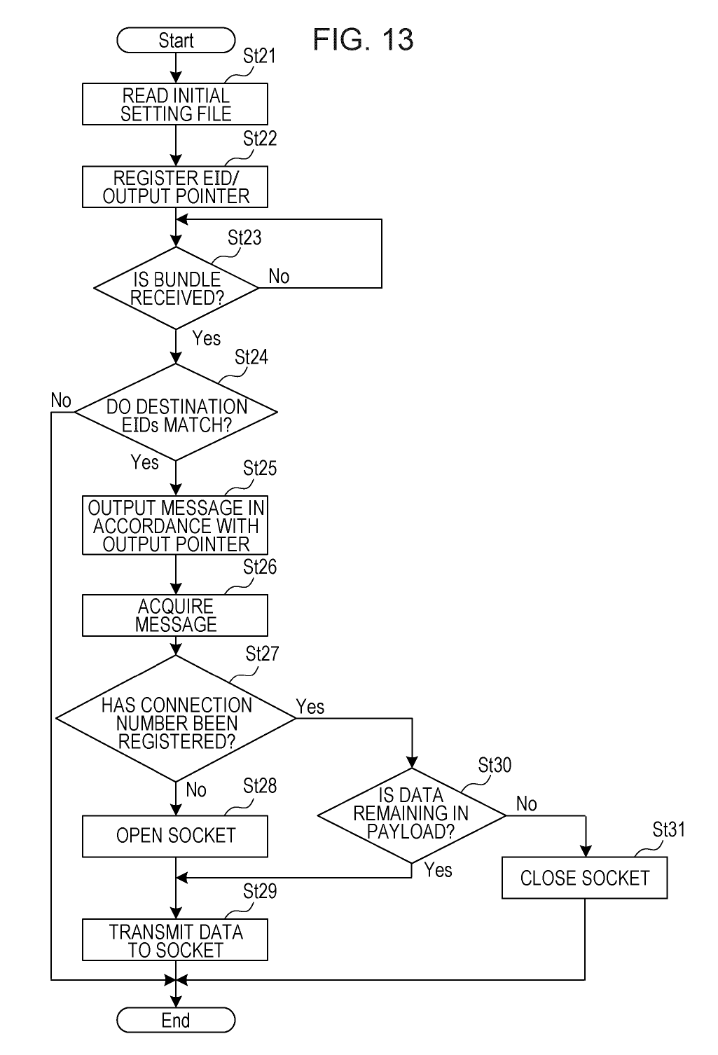

FIG. 13 is a flowchart illustrating an example of the bundle reception processing. The proxy control units 111 and 211 read the initial setting files 117 and 217 (operation St21). The proxy control units 111 and 211 register the node EID and the output pointer with the bundle API in accordance with the initial setting files 117 and 217 so that the bundle control units 120 and 220 may receive a bundle from the applications 201 and 101 being the communication partners (Operation St22). Thus, when receiving the bundle, the bundle control units 120 and 220 output the bundle to the designated directory of the output pointer “data/receive”.

The bundle control units 120 and 220 determine whether or not the bundle has been received (operation St23). If the bundle is not received (No in operation St23), the bundle control units 120 and 220 execute the processing of operation St23 again. If the bundle has been received (Yes in operation St23), the bundle control units 120 and 220 determine whether or not the EID registered in operation St22 and the destination EID of the bundle match (operation St24).

If the registered EID and the destination EID of the bundle do not match (No in operation St24), which means that the bundle is not a bundle addressed to the own devices, the bundle control units 120 and 220 discard the bundle and end the processing. If the registered EID and the destination EID of the bundle match (Yes in operation St24), the bundle control units 120 and 220 acquire packet data from the payload of the bundle for generation of a proxy message to output the proxy message to the designated directory of the output pointer (operation St25).

The proxy control units 111 and 211 refer to the designated directory of the output pointer to acquire the proxy message (operation St26). The proxy control units 111 and 211 determine whether or not the connection number of the proxy message has been registered in the connection lists 116 and 216 (operation St27).

If the connection number is unregistered (No in operation St27), the proxy control units 111 and 211 instruct the transmission/reception control units 114 and 214 to open the socket with the proxy port number designated by the initial setting files 117 and 217 (operation St28). In addition, if the connection number has been registered (Yes in operation St27), the proxy control units 111 and 211 determine whether or not packet data is accommodated in the payload of the proxy message (operation St30).

If packet data is accommodated (Yes in operation St30), the proxy control units 111 and 211 transmit the data to the corresponding socket (operation St29). If the packet data is not accommodated (No in operation St30), the proxy control units 111 and 211 instruct the transmission/reception control units 114 and 214 to close the corresponding socket (operation St31). As described above, the bundle reception processing is executed.

As described above, the proxy protocol function units 110 and 210 open and close sockets based on the operation of the applications between the application 101 of the terminal 1 and the application 201 of the server 2, regardless of the presence or absence of connection between the terminal 1 and the server 2. This makes it possible to continue communication between the application 101 and the application 201 even if the connection is disconnected.

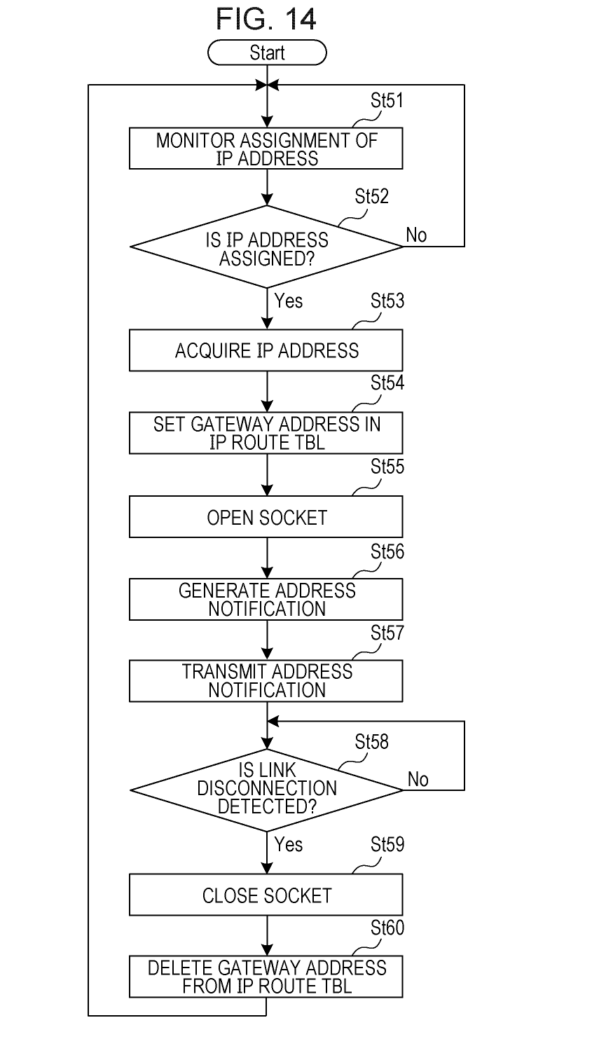

FIG. 14 is a flowchart illustrating an example of processing of the route control unit 124 of the terminal 1. The route control unit 124 monitors the OS function unit 130 for the assignment of an IP address (operation St51). The OS function unit 130 is assigned an IP address by DHCP communication with the wireless access point AP of the link destination of the terminal 1. As a result, the monitoring of the OS function unit 130 makes it possible for the route control unit 124 to detect that the terminal 1 has been connected to the wireless LAN

The route control unit 124 determines whether or not an IP address has been assigned from the monitoring results (operation St52). If an IP address is unassigned (No in operation St52), the route control unit 124 executes the processing of operation St51 again.

In addition, if an IP address has been assigned (Yes in operation St52), the route control unit 124 acquires that IP address from the OS function unit 130 (operation St53). The route control unit 124 sets the gateway address corresponding to the acquired IP address in the IP route TBL 131 (operation St54). The gateway address is decided by DHCP. Since the bundle is routed in accordance with the IP route TBL 131, a communication route from the terminal 1 to the server 2 is generated when the gateway address is set in the IP route TBL 131.

The route control unit 124 opens a communication socket for the server 2 in the bundle control unit 120 (operation St55). The route control unit 124 generates an address notification including the IP address and the node EID (operation St56). Note that the node EID is acquired from the initial setting file 117.

The route control unit 124 transmits the address notification to the server 2 with the bundle control unit 120 (operation St57). This makes it possible for the server 2 to know the new IP address of the terminal 1 even when the wireless LAN of the connection destination of the terminal 1 is switched.

The route control unit 124 monitors the OS function unit 130 to determine whether or not the disconnection of link with the wireless access point AP has been detected (operation St58). If there is no link disconnection (No in operation St58), the route control unit 124 executes the processing of operation St58 again. In addition, if link disconnection takes place (Yes in operation St58), the route control unit 124 closes the socket of the bundle control unit 120 (operation St59).

The route control unit 124 deletes the gateway address from the IP route TBL 131 (operation St60) and executes the processing of operation St51 again. As described above, the processing of the route control unit 124 is executed.

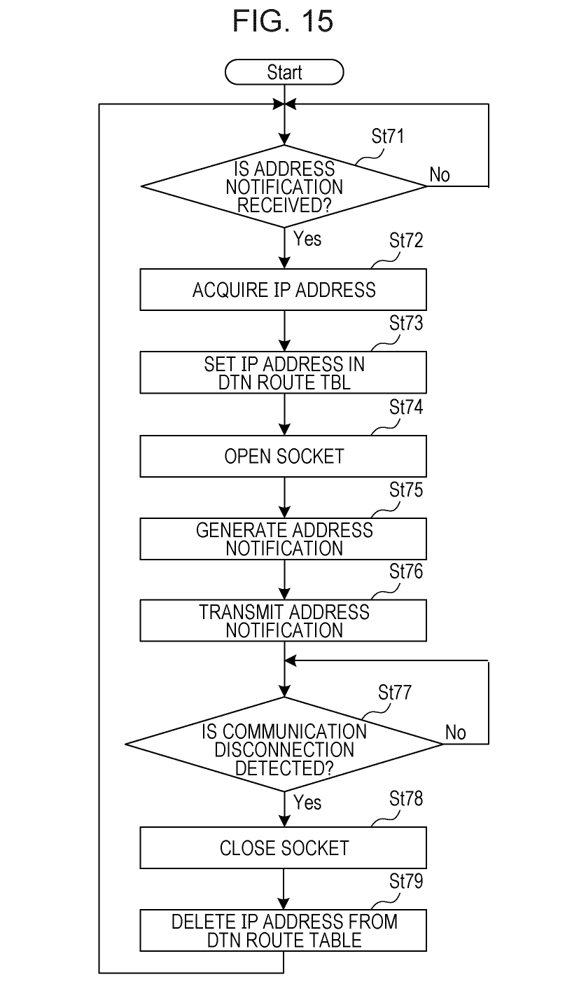

FIG. 15 is a flowchart illustrating an example of processing of the route control unit 224 of the server 2. The route control unit 224 determines whether or not an address notification has been received from the route control unit 124 of the terminal 1 (operation St71). If an address notification is not received (No in operation St71), the route control unit 224 executes the processing of operation St71 again.

In addition, if an address notification has been received (Yes in operation St71), the route control unit 224 acquires from the address notification the IP address of the terminal 1 as the transmission source IP address (operation St72). The route control unit 224 sets the acquired IP address in the DTN route TBL 223 (operation St73). Here, the IP address is registered in the next hop address corresponding to the node EID of the terminal 1 included in the address notification.

The route control unit 224 opens a communication socket for the terminal 1 in the bundle control unit 220 (operation St74). The route control unit 224 generates an address notification including the IP address and the node EID (operation St75). Note that the node EID is acquired from the initial setting file 217.

The route control unit 224 transmits the address notification to the terminal 1 with the bundle control unit 220 (operation St76). This makes it possible for the terminal 1 to confirm the response of the address notification transmitted to the server 2.

The route control unit 224 monitors the OS function unit 230 to determine whether or not the disconnection of communication with the terminal 1 has been detected (operation St77). If there is no communication disconnection (No in operation St77), the route control unit 224 executes the processing of operation St77 again. In addition, if communication disconnection takes place (Yes in operation St77), the route control unit 224 closes the socket of the bundle control unit 220 (operation St78).

The route control unit 224 deletes the address of the terminal 1 from the DTN route TBL 223 (operation St79) and executes the processing of operation St71 again. As described above, the processing of the route control unit 224 is executed.

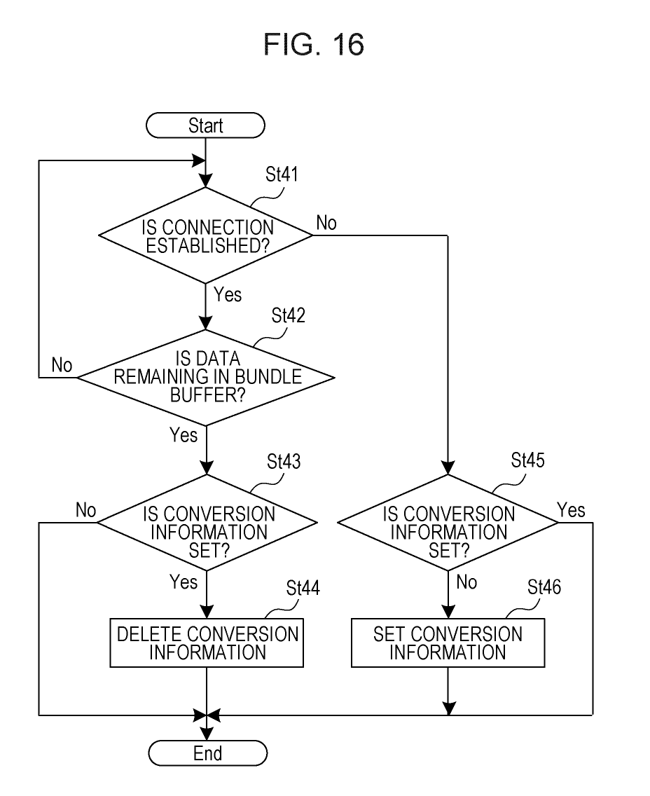

FIG. 16 is a flowchart illustrating an example of switch processing of the applying of a bundle protocol. The connection monitoring units 112 and 212 detect the presence or absence of connection with the communication destination (operation St41).

The bundle control units 120 and 220 detect the communication status using the keepalive function and the connection status with the corresponding communication destination based on the IP address and the port number set in the DTN route TBLs 123 and 223. The connection monitoring units 112 and 212 acquire the detection results of the bundle control units 120 and 220 or detect the connection status by control with the bundle API or the like.

If a connection is established (Yes in operation St41), the connection monitoring units 112 and 212 determine whether or not a bundle waiting for transmission is stored in the bundle buffers 122 and 222 (operation St42). If there is no stored bundle (No in operation St42), the connection monitoring units 112 and 212 execute the processing of operation St41 again.

In addition, if there is a stored bundle (Yes in operation St42), the connection monitoring units 112 and 212 refer to the setting state of the filter TBLs 118 and 218 to determine whether or not conversion information is set for the address conversion units 113 and 213 (operation St43). If no conversion information is set (No in operation St43), the connection monitoring units 112 and 212 end the processing. If conversion information is set (Yes in operation St43), the connection monitoring units 112 and 212 delete the conversion information (operation St44).

This stops the forwarding of packets from the TCP processing units 102 and 202 to the sockets of the transmission/reception control units 114 and 214. As a result, direct TCP/IP communication not involving the proxy protocol function units 110 and 210 is performed because the applying of the bundle protocol to the communication between the applications 101 and 201 is stopped.

On the other hand, if the connection is disconnected (No in operation St41), the connection monitoring units 112 and 212 refer to the setting state of the filter TBLs 118 and 218 to determine whether or not conversion information is set for the address conversion units 113 and 213 (operation St45). If conversion information is set (Yes in operation St45), the connection monitoring units 112 and 212 end the processing. In addition, if no conversion information is set (No in operation St45), the connection monitoring units 112 and 212 set the conversion information (operation St46).

This starts the forwarding of packets from the TCP processing units 102 and 202 to the sockets of the transmission/reception control units 114 and 214. As a result, communication involving the proxy protocol function units 110 and 210 is performed because the applying of the bundle protocol to the communication between the applications 101 and 201 is started.

As described above, the connection monitoring units 112 and 212 detect the connection status with the communication destination, and decide depending on the connection status whether to apply the bundle protocol to the communication between the applications 101 and 201. For this reason, the bundle protocol is automatically applied.

Next, EID assignment in the communication system of FIG. 1 is described.

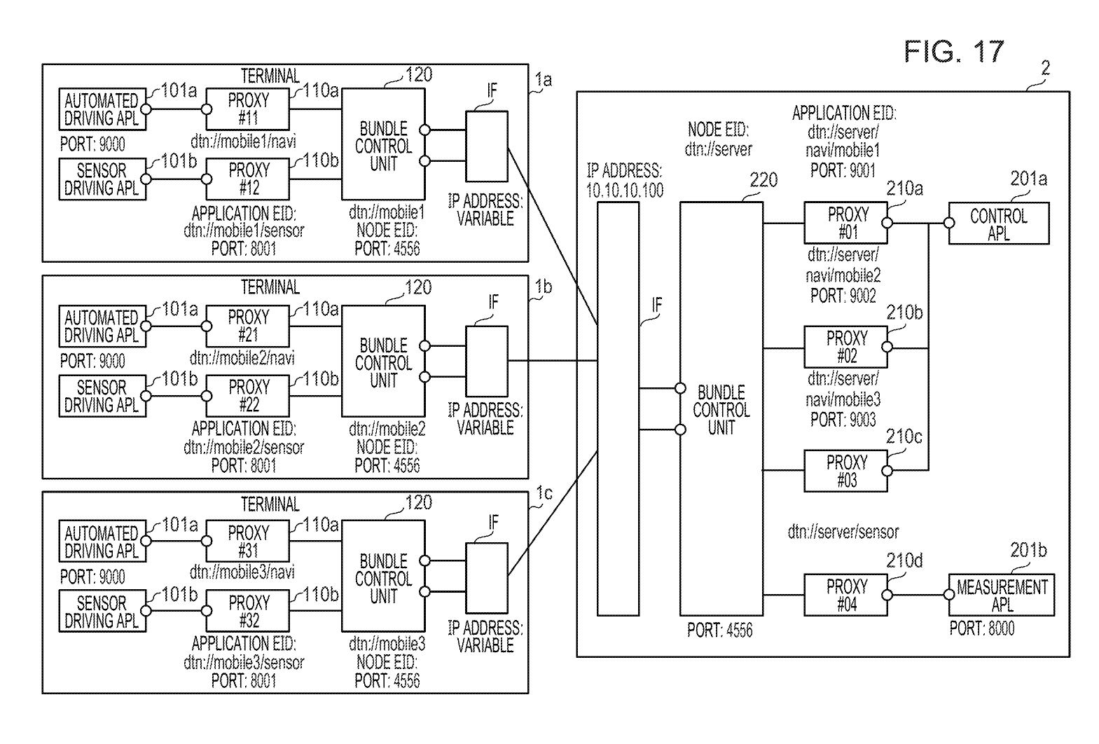

FIG. 17 is a diagram illustrating an example of EID assignment. In FIG. 17, white circles each indicate a socket for transmitting and receiving data. The EID and the port number are assigned by the initial setting files 117 and 217.

In each of the terminals 1a to 1c, the automated driving APL 101a and the sensor APL 101b each have a corresponding proxy protocol function unit 110. The terminal 1a is provided with a proxy #11 which is a proxy protocol function unit 110a corresponding to the automated driving APL 101a and a proxy #12 which is a proxy protocol function unit 110b corresponding to the sensor APL 101b.

The proxy #11 is assigned the application EID “dtn://mobile1/navi” and the proxy #12 is assigned the application EID “dtn://mobile1/sensor”. The proxy #11 transmits data to the socket of the automated driving APL 101a with the port number “9000”, and the proxy #12 receives data from the sensor APL 101b at the socket with the port number “8001”.

In addition, the bundle control unit 120 is assigned the node EID “dtn://mobile1”. The bundle control unit 120 receives data from the bundle control unit 220 of the server 2 at the socket with the port number “4556”.

The terminal 1b is provided with a proxy #21 which is a proxy protocol function unit 110a corresponding to the automated driving APL 101a and a proxy #22 which is a proxy protocol function unit 110b corresponding to the sensor APL 101b.

The proxy #21 is assigned the application EID “dtn://mobile2/navi” and the proxy #22 is assigned the application EID “dtn://mobile2/sensor”. The proxy #21 transmits data to the socket of the automated driving APL 101a with the port number “9000”, and the proxy #22 receives data from the sensor APL 101b at the socket with the port number “8001”.

In addition, the bundle control unit 120 is assigned the node EID “dtn://mobile2”. The bundle control unit 120 receives data from the bundle control unit 220 of the server 2 at the socket with the port number “4556”.

The terminal 1c is provided with a proxy #31 which is a proxy protocol function unit 110a corresponding to the automated driving APL 101a and a proxy #32 which is a proxy protocol function unit 110b corresponding to the sensor APL 101b.

The proxy #31 is assigned the application EID “dtn://mobile3/navi” and the proxy #32 is assigned the application EID “dtn://mobile3/sensor”. The proxy #31 transmits data to the socket of the automated driving APL 101a with the port number “9000”, and the proxy #32 receives data from the sensor APL 101b at the socket with the port number “8001”.

In addition, the bundle control unit 120 is assigned the node EID “dtn://mobile3”. The bundle control unit 120 receives data from the bundle control unit 220 of the server 2 at the socket with the port number “4556”.

The bundle control unit 120 of each of the terminals 1a to 1c transmits and receives data via the interface IF. The interface IF is the wireless LAN module 14, for example, and its IP address is variable.

On the other hand, in the server 2, the communication destinations of the control APL 201a and the measurement APL 201b each have a corresponding proxy protocol function unit 210. The proxy #01 is a proxy protocol function unit 210a corresponding to the automated driving APL 101a of the terminal 1a and is assigned the application EID “dtn://server/navi/mobile1”.

The proxy #02 is a proxy protocol function unit 210b corresponding to the automated driving APL 101a of the terminal 1b and is assigned the application EID “dtn://server/navi/mobile2”. The proxy #03 is a proxy protocol function unit 210c corresponding to the automated driving APL 101a of the terminal 1c and is assigned the application EID “dtn://server/navi/mobile3”.

The proxy #01 receives data from the control APL 201a at the socket with the port number “9001”, and the proxy #02 receives data from the control APL 201a at the socket with the port number “9002”. In addition, the proxy #03 receives data from the control APL 201a at the socket with the port number “9003”.

Since the terminals 1a to 1c have a server function in the communication addressed from the control APL 201a to the automated driving APL 101a, the terminals 1a to 1c require the proxies #11, #21, and #31 corresponding to the automated driving APL 101a, and the server 2 requires the proxies #01 to #03 corresponding to the proxies #11, #21, and #31. Since a communication destination is designated by an application EID in bundle protocol communication, it is possible to designate a communication destination even when the IP addresses of the terminals 1a to 1c are undecided.

However, since the control APL 201a designates a communication destination with an IP address and a port number, it is impossible to designate the terminals 1a to 1c with undecided IP addresses as a communication destination. For this reason, the assignment of individual port numbers “9001” to “9003” to the proxies #01 to #03 makes it possible for the control APL 201a to virtually designate the terminals 1a to 1c as a communication destination.

In addition, proxy #04 is a proxy protocol function unit 210d corresponding to the measurement APL 201b and is assigned the application EID “dtn://server/sensor”. The proxy #04 transmits data to the socket of the measurement APL 201b with the port number “8000”.

In addition, the bundle control unit 220 is assigned the node EID “dtn://server”. The bundle control unit 220 receives data from the bundle control units 120 of the terminals 1a to 1c at the socket with the port number “4556”.

The bundle control unit 220 transmits and receives data via the interface IF. The interface IF is the communication port 24, for example, and its IP address is “10.10.10.100”. Hereinafter, description is provided for the communication addressed from the control APL 201a to the automated driving APL 101a of the terminal 1c as an example on the premise of the assignment of an EID and a port number described above.

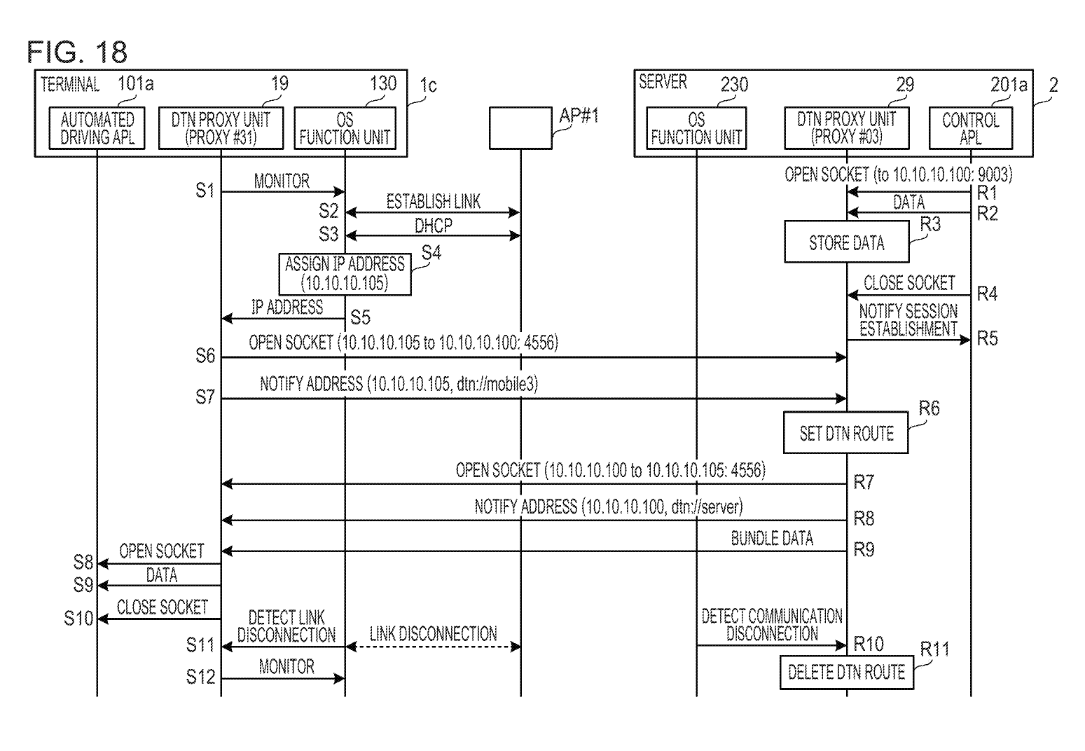

FIG. 18 is a sequence diagram illustrating an example of communication addressed from the control APL 201a to the automated driving APL 101a. FIG. 18 illustrates the communication operation between the automated driving APL 101a, the DTN proxy unit 19 including the proxy #31, and the OS function unit 130 of the terminal 1c and the control APL 201a, the DTN proxy unit 29 including the proxy #03, and the OS function unit 230 of the server 2. This example illustrates the communication when the terminal 1c is linked with the wireless access point AP #1.

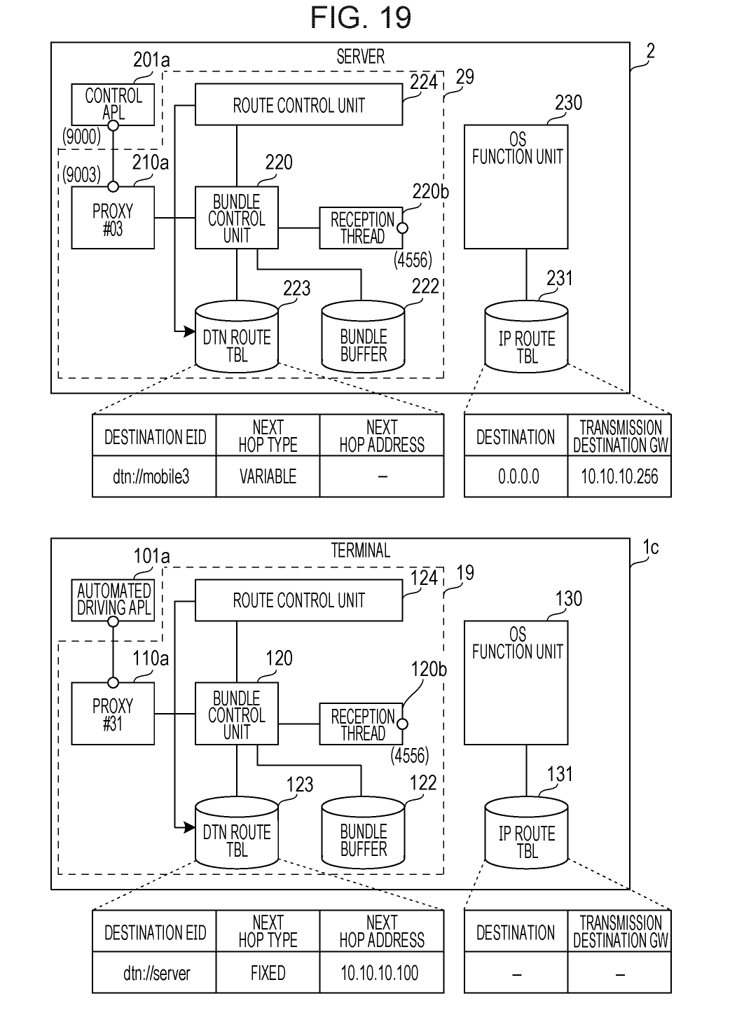

In addition, FIGS. 19 to 23 illustrate the operation inside the terminal 1c and the server 2 following the sequence of this example. Note that in FIGS. 19 to 23, the numbers in parentheses indicate port numbers.

FIG. 19 illustrates the state of the terminal 1c and the server 2 before the start of the sequence. The route control unit 224 of the server 2 generates a reception thread 220b for receiving data from the DTN proxy unit 19 of the terminal 1c to the bundle control unit 120. The reception thread 220b corresponds to the socket with the port number “4556”.

Further, the route control unit 124 of the terminal 1c generates a reception thread 120b for receiving data from the DTN proxy unit 29 of the server 2 to the bundle control unit 220. The reception thread 120b corresponds to the socket with the port number “4556”.

In the DTN route TBL 223 of the server 2, the node EID of the terminal 1c “dtn://mobile3” is set as the destination EID, and “Variable” is set as the next hop type. In addition, since the IP address of the terminal 1c is undecided, the next hop address is not set. Note that the port number of the DTN route TBL 223 is omitted. In addition, the gateway address “10.10.10.256” is set in the IP route TBL 231 as the transmission destination gateway (GW).

In the DTN route TBL 123 of the terminal 1c, the node EID of the server 2 “dtn://server” is set as the destination EID, and “Fixed” is set as the next hop type. In addition, the IP address “10.10.10.100” of the server 2 is set as the next hop address.

In addition, the server 2 activates the proxy #03 in correspondence to the control APL 201a whose communication destination is the automated driving APL 101a of the terminal 1c. The proxy #03 opens the socket with the port number “9003” and waits for communication from the control APL 201a. Note that the control APL 201a opens the socket with the port number “9000” for data transmission. Moreover, the terminal is activates the proxy #31 in correspondence to the automated driving APL 101a.

Reference to FIG. 18 reveals that the DTN proxy unit 19 of the terminal 1c monitors the OS function unit 130 in order to detect the assignment of an IP address (reference numeral S1). In addition, when starting a session with the automated driving APL 101a, the control APL 201a of the server 2 opens a socket to the DTN proxy unit 29 (reference numeral R1). This socket corresponds to the socket SC6 in FIG. 10, and its communication destination is the IP address “10.10.10.100” and the port number “9003” of the proxy #03.

The control APL 201a transmits data from the socket to the DTN proxy unit 29 (reference numeral R2). Here, since the IP address of the terminal 1c as the destination is not set in the DTN route TBL 223, the transmitted data is stored in the bundle buffer 122 (reference numeral R3). The control APL 201a closes the socket (reference numeral R4).

In addition, the DTN proxy unit 29 notifies the control APL 201a of the establishment of a session (reference numeral R5). Specifically, when requested by the control APL 201a for communication with the automated driving APL 101a, the DTN proxy unit 29 notifies the control APL 201a of the establishment of a session.

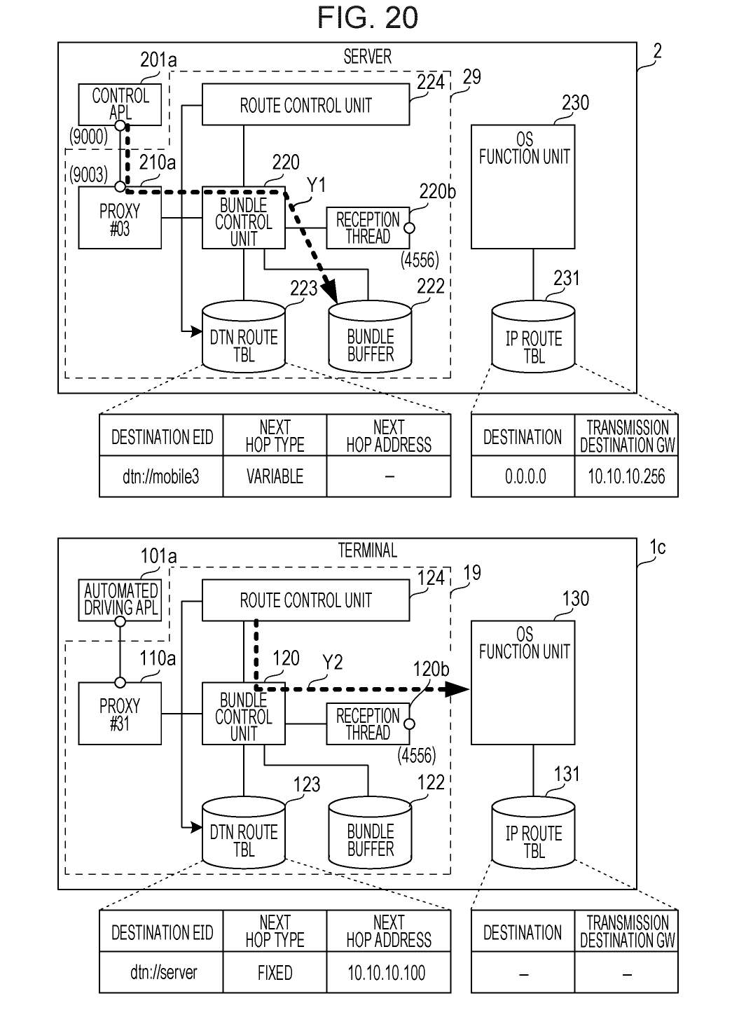

FIG. 20 illustrates the operations of reference numerals S1, R1, and R2 in FIG. 18. The control APL 201a in the server 2 transmits data (that is, a speed instruction) to the proxy #03, and the proxy #03 converts the data to a proxy message for transmission to the bundle control unit 220. The bundle control unit 220 obtains the node EID “dtn://mobile3” from the EID of the destination application “dtn://mobile3/navi” and searches the DTN route TBL 123 based on the node EID “dtn://mobile3”.

However, the IP address corresponding to the terminal 1c as the communication destination is not set in the next hop address of the DTN route TBL 123. For this reason, the bundle control unit 220 generates a bundle from the proxy message but stores the bundle in the bundle buffer 222 (reference numeral Y1) because its destination is unknown. Moreover, in the terminal 1c, the route control unit 124 monitors the OS function unit 130 (reference numeral Y2).

Reference to FIG. 18 reveals that, when the terminal 1c enters the coverage area of the wireless LAN #11, the OS function unit 130 establishes a link with the wireless access point AP #1 (reference numeral S2). The OS function unit 130 performs DHCP communication with the wireless access point AP #1 (reference numeral S3), and the IP address “10.10.10.105” is assigned to the terminal 1c (reference numeral S4). The DTN proxy unit 19 acquires the IP address from the OS function unit 130 (reference numeral S5).

The DTN proxy unit 19 opens a socket to the DTN proxy unit 29 as the communication destination (reference numeral S6). This socket corresponds to the socket SC3 in FIG. 10, and its communication destination is the IP address “10.10.10.100” and the port number “4556” of the bundle control unit 220. The DTN proxy unit 19 generates an address notification including the IP address “10.10.10.105” and the node EID “dtn://mobile3” for transmission to the DTN proxy unit 29 of the server 2 (reference numeral S7). Specifically, the DTN proxy unit 19 notifies the DTN proxy unit 29 of the server 2 of the IP address of the terminal 1c in the wireless LAN #11 after switching. Note that the IP address is an example of identification information in the wireless LAN #11.

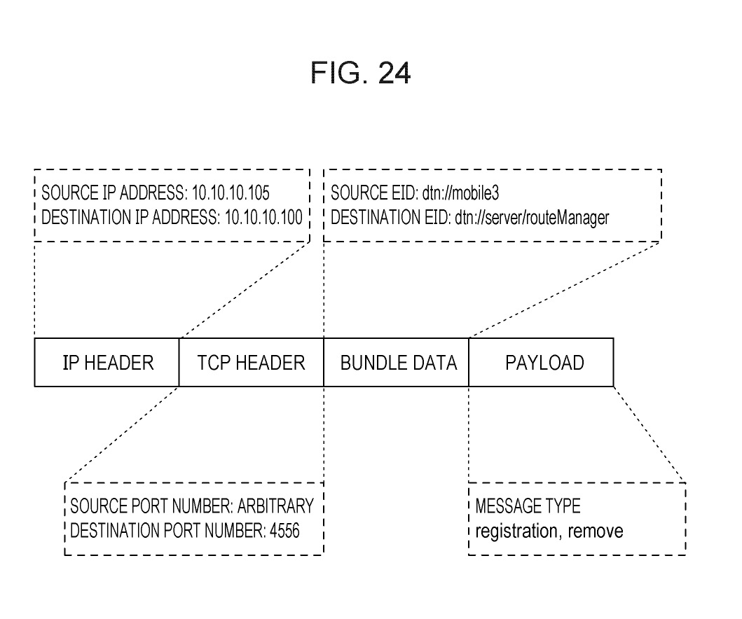

FIG. 24 is a diagram illustrating an example of address notification. The address notification includes an IP header, a TCP header, bundle data, and a payload. The IP header includes the transmission source IP address “10.10.10.105” and the destination IP address “10.10.10.100”. The TCP header includes an arbitrary transmission source port number and the destination port number “4556”.

Also, the bundle data includes the node EID of the terminal 1c “dtn://mobile3” as the transmission source EID, and designates the EID of the route control unit 224 of the server 2 “dtn://server/routeManager” as the destination EID. The EID of the route control unit 224 is set in, for example, the initial setting file 217. Moreover, the payload includes “registration” or “remove” as a message type, for example.

Reference again to FIG. 18 reveals that, when receiving an address notification, the DTN proxy unit 29 acquires an IP address from the address notification and sets the IP address in the DTN route TBL 223 so that it corresponds to the node EID in the address notification (reference numeral R6). More specifically, the route control unit 224 sets the transmission source IP address of the address notification in the DTN route TBL 223 so that it corresponds to the destination EID of the address notification.

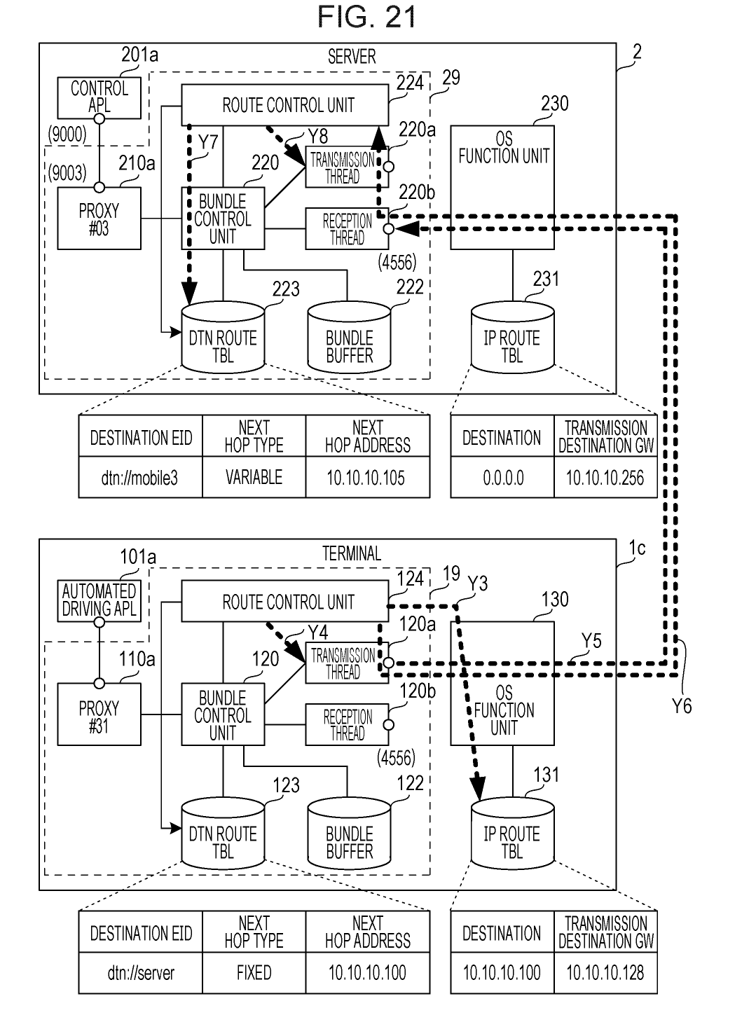

FIG. 21 illustrates the operations of reference numerals S5 to S7 and R6 in FIG. 18. When acquiring an IP address, the route control unit 124 of the terminal 1c sets the gateway address “10.10.10.128” corresponding to the IP address in the IP route TBL 131 so that is corresponds to the IP address of the server 2 “10.10.10.100” (reference numeral Y3).

The route control unit 124 generates for the bundle control unit 120 a transmission thread 120a whose communication destination is the server 2 (reference numeral Y4), and opens a socket for transmitting data to the reception thread of the server 2 (reference numeral Y5). This generates a communication route from the automated driving APL 101a to the control APL 201a so as to correspond to the session established between the automated driving APL 101a and the control APL 201a.

The route control unit 124 generates an address notification for transmission from the transmission thread 120a to the route control unit 224 of the server 2 (reference numeral Y6). In the server 2, the address notification is outputted from the reception thread 220b to the route control unit 224.

The route control unit 224 of the server 2 sets the IP address of the terminal 1c in the DTN route TBL 223 (reference numeral Y7). The route control unit 224 generates for the bundle control unit 220 a transmission thread 220a whose communication destination is the terminal 1c (reference numeral Y8).

Reference to FIG. 18 reveals that the DTN proxy unit 29 opens a socket to the DTN proxy unit 19 as the communication destination (reference numeral R7). This socket corresponds to the socket SC4 in FIG. 10, and its communication destination is the IP address “10.10.10.105” and the port number “4556” of the bundle control unit 120.

This generates a communication route from the control APL 201a to the automated driving APL 101a. Specifically, the route control unit 224 generates a communication route based on the IP address notified by the DTN proxy unit 19 of the terminal 1c so that it corresponds to the session established between the automated driving APL 101a and the control APL 201a. For this reason, the control APL 201a may identify the terminal 1c as the communication destination using the IP address.

The DTN proxy unit 29 generates an address notification including the IP address “10.10.10.100” and the node EID “dtn://server” for transmission to the DTN proxy unit 19 of the terminal 1c (reference numeral R8).

The DTN proxy unit 29 reads bundle data from the bundle buffer 222 for transmission to the DTN proxy unit 19 of the terminal 1c (reference numeral R9). The DTN proxy unit 19 of the terminal 1c opens a socket to the automated driving APL 101a as the communication destination (reference numeral S8). This socket corresponds to the socket SC2 in FIG. 10. The DTN proxy unit 19 transmits data from the socket to the automated driving APL 101a (reference numeral S9), and closes the socket (reference numeral S10).

As described above, after switching over the wireless LAN of the connection destination of the terminal 1c, the DTN proxy unit 19 of the terminal 1c establishes a session with the automated driving APL 101a in response to the address notification from the DTN proxy unit 29 of the server 2. In addition, when requested by the control APL 201a for communication with the automated driving APL 101a, the DTN proxy unit 29 of the server 2 notifies the control APL 201a of the establishment of a session. For this reason, the DTN proxy unit 19 of the terminal 1c may relay the communication, addressed from the control APL 201a to the automated driving APL 101a, to the DTN proxy unit 29 of the server 2 while dealing with switching of the wireless LAN.

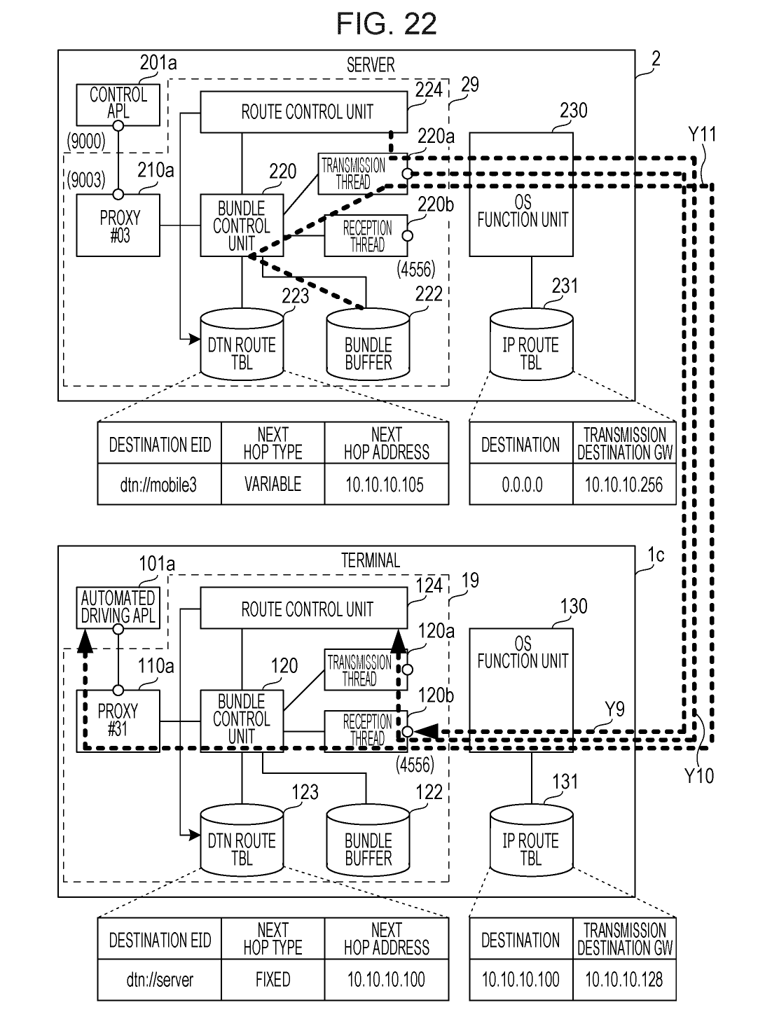

FIG. 22 illustrates the operations of reference numerals S8 to S10 and R7 to R9 in FIG. 18. The route control unit 224 of the server 2 opens a socket whose communication destination is the reception thread 120b of the terminal 1c (reference numeral Y9). The route control unit 224 generates an address notification for transmission from the transmission thread 220a to the route control unit 124 of the terminal 1c (reference numeral Y10). The bundle control unit 220 reads a bundle from the bundle buffer 222 for transmission from the transmission thread 220a to the terminal 1c (reference numeral Y11).

The bundle control unit 120 of the terminal 1c converts the bundle to a proxy message for output to the proxy #31. The proxy #31 opens a socket to the automated driving APL 101a and transmits data of the proxy message from the socket to the automated driving APL 101a.

Reference to FIG. 18 reveals that, when the terminal 1c moves out of the coverage area of the wireless LAN #11, the link between the terminal 1c and the wireless access point AP #1 is disconnected. The DTN proxy unit 19 detects link disconnection by the OS function unit 130 (reference numeral S11). The DTN proxy unit 19 again monitors the OS function unit 130 in preparation for the link with another wireless access point AP (reference numeral S12). Thereafter, the sequence of this example is repeated.

In addition, the DTN proxy unit 29 of the server 2 detects by the OS function unit 230 that communication with the terminal 1c is disconnected (reference numeral R10). The DTN proxy unit 29 deletes the settings based on the address notification of the terminal 1c from the DTN route TBL 223 (reference numeral R11).

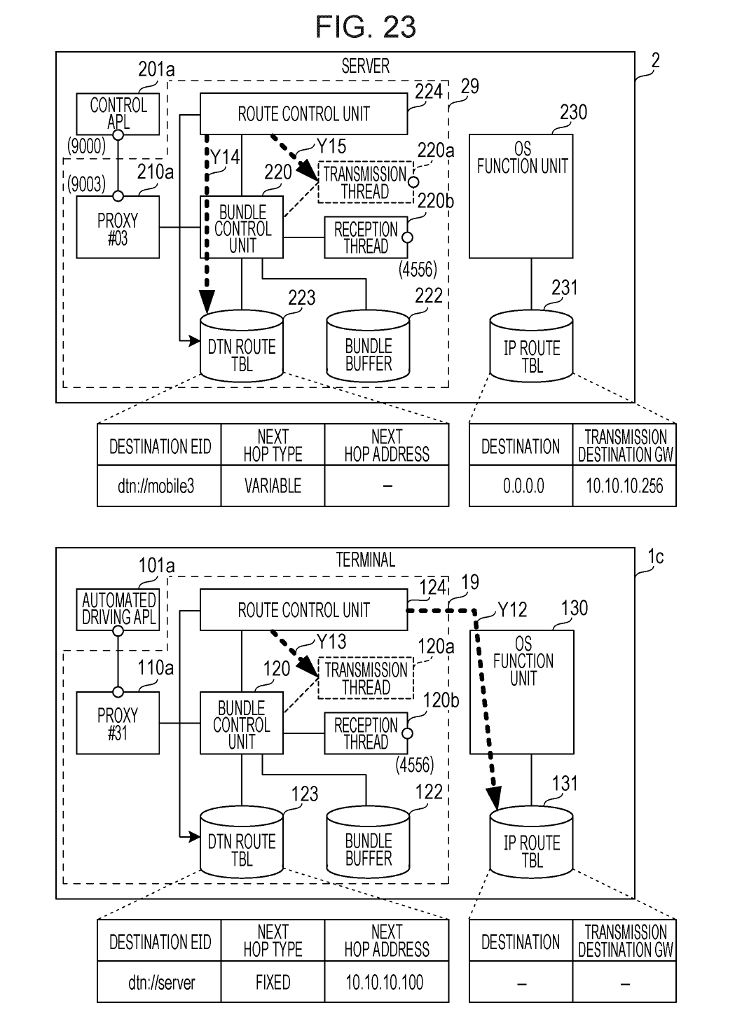

FIG. 23 illustrates the operations of reference numerals S11 and R11 in FIG. 18. The route control unit 124 in the terminal 1c deletes the settings of the gateway address from the IP route TBL 131 (reference numeral Y12). Moreover, the route control unit 124 deletes the transmission thread 120a of the bundle control unit 120 (reference numeral Y13).

In addition, the route control unit 224 in the server 2 deletes the IP address of the terminal 1c from the DTN route TBL 223 (reference numeral Y14). Moreover, the route control unit 224 deletes the transmission thread 220a of the bundle control unit 220 (reference numeral Y14). This returns the terminal 1c and the server 2 to the initial state illustrated in FIG. 19.

In the sequence of this example, the DTN proxy unit 29 of the server 2 relays the communication addressed from the control APL 201a to the automated driving APL 101a, and the DTN proxy unit 19 of the terminal 1c forwards the communication relayed from the DTN proxy unit 29 of the server 2 to the automated driving APL 101a. The DTN proxy units 19 and 29 generate a communication route corresponding to the session established by the communication between the control APL 201a and the automated driving APL 101a.

More specifically, when detecting the assignment of an IP address, the DTN proxy unit 19 sets the IP route TBL 131, opens a socket to the DTN proxy unit 29 of the server 2, and notifies the DTN proxy unit 29 of the IP address using the address notification. On the other hand, the DTN proxy unit 29 sets the IP address notified by the address notification in the DTN route TBL 223, and opens a socket to the DTN proxy unit 29 of the terminal 1c.

Thus, the DTN proxy units 19 and 29 maintain a session between the control APL 201a and the automated driving APL 101a by using the generated communication route while dealing with switching of the wireless LAN to which the terminal 1c is connected. More specifically, even when the wireless LAN access point AP of the connection destination of the terminal 1c is switched, it is possible to continue the session between the control APL 201a and the automated driving APL 101a because the DTN proxy units 19 and 29 newly generate a communication route by IP address notification in the wireless LAN after switching. Hence, it is possible to continue the communication between the control APL 201a and the automated driving APL 101a while dealing with the change in the network connection environment of the terminal 1c.

Therefore, in the case of, for example, the communication system in FIG. 3, the server 2 may unilaterally provide a speed instruction to the terminal 1c by, for example, push type communication because the server 2 may know the IP address by receiving an address notification from the terminal 1c.

Next, a description is provided for the sequence in the case where the communication is interrupted by the switching of the wireless LAN during the transmission of bundle data.

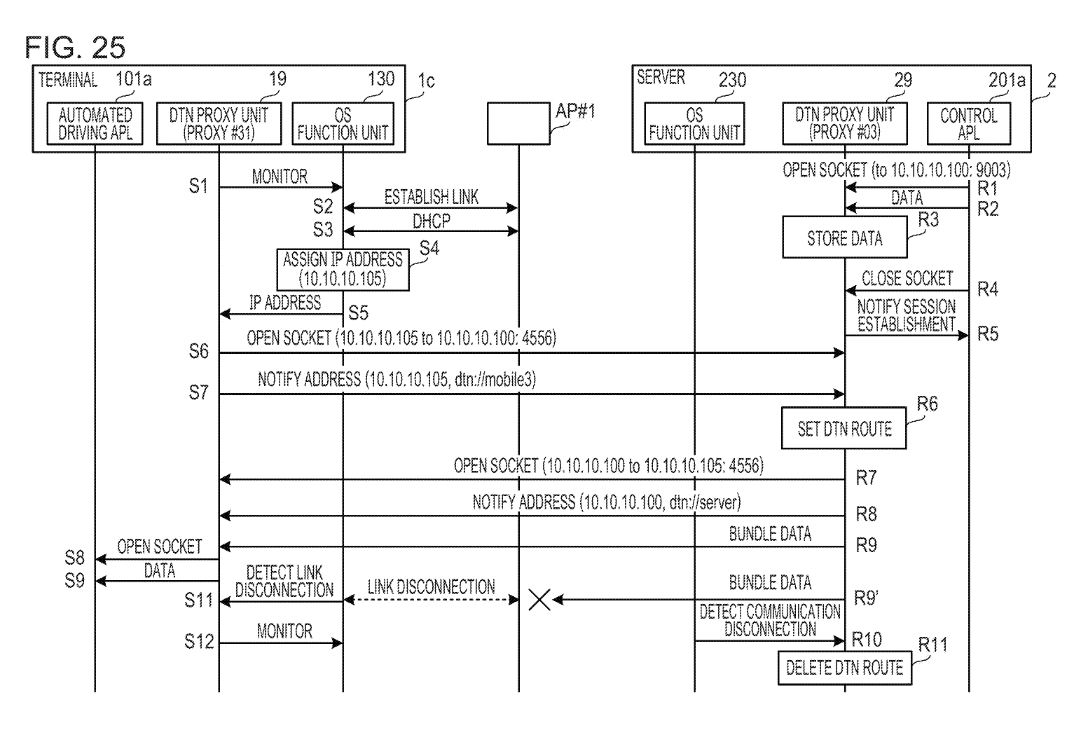

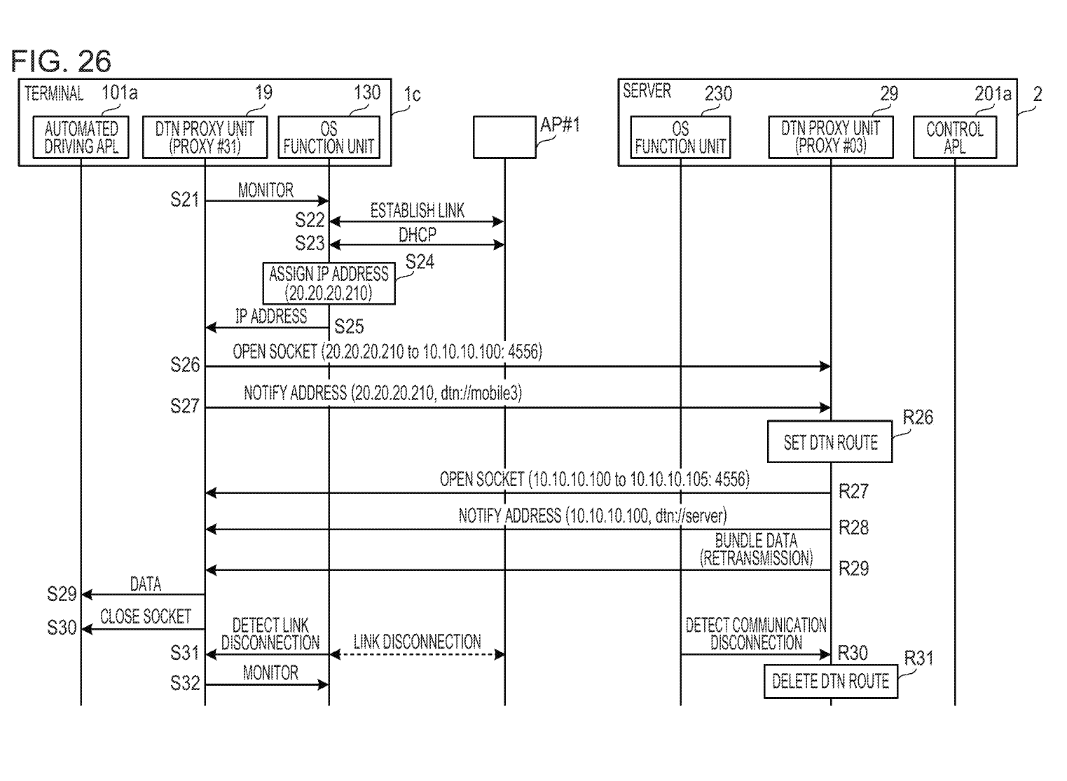

FIGS. 25 and 26 are each a sequence diagram illustrating another example of the communication addressed from the control APL 201a to the automated driving APL 101a. In this example, the terminal 1c is linked with the wireless access point AP #1 and then is linked with another wireless access point AP #2. Consequently, the wireless LAN as the connection destination of the terminal 1c is switched from the wireless LAN #11 to the wireless LAN #12.

FIG. 25 illustrates a sequence from when the terminal 1c is linked with the wireless access point AP #1 to when the link is disconnected. In FIG. 25, operations common to those in FIG. 18 are denoted by the same reference numerals, and description thereof is omitted.

The DTN proxy unit 29 of the server 2 is interrupted because the forwarding of bundle data fails to complete due to the link disconnection between the terminal 1c and the wireless access point AP #1 (reference numerals R9 and R9′). The DTN proxy unit 19 of the terminal 1c keeps the socket to the automated driving APL 101a open because data reception is not completed.

FIG. 26 illustrates a sequence from when the terminal 1c is linked with another wireless access point AP #2 to when the link is disconnected. In FIG. 26, since the operations of reference numerals S21 to S27, S29 to S32, and R26 to R31 are the same as the operations of reference numerals S1 to S7, S9 to S12, and R6 to R11 in FIG. 18, their detailed description is omitted as appropriate.

The DTN proxy unit 19 of the terminal 1c monitors the OS function unit 130 (reference numeral S21) to detect that the terminal 1c is assigned a new IP address “20.20.20.210” (reference numerals S24 and S25). The DTN proxy unit 19 sets the IP address in the IP route TBL 131, opens a socket to the DTN proxy unit 29 of the server 2 (reference numeral S26), and transmits an address notification (reference numeral S27).

When receiving an address notification, the DTN proxy unit 29 of the server 2 sets the new IP address of the terminal 1c “20.20.20.210” in the DTN route TBL 223 (reference numeral R26). The DTN proxy unit 29 opens a socket to the DTN proxy unit 19 of the terminal 1c (reference numeral R27) and transmits an address notification (reference numeral R28). Consequently, the DTN proxy units 19 and 29 generate a new communication route corresponding to the session between the control APL 201a and the automated driving APL 101a.

The DTN proxy unit 29 retransmits the bundle data, failed in transmission due to the interruption of communication, to the DTN proxy unit 19 of the terminal 1c (reference numeral R29). The DTN proxy unit 19 transmits the data from the opened socket to the automated driving APL 101a (reference numeral S29) and closes the socket (reference numeral S30). This completes the communication interrupted due to the switching of the wireless LAN because each of the bundles failed in transmission is retransmitted in the bundle protocol.

As described above, the DTN proxy units 19 and 29 use the communication route corresponding to the session between the control APL 201a and the automated driving APL 101a to continue the communication addressed from the control APL 201a to the automated driving APL 101a interrupted by the switching of the wireless LAN. Therefore, it is possible to complete the communication addressed from the control APL 201a to the automated driving APL 101a.

Next, a description is provided for a sequence of communication from the sensor APL 101b of the terminal 1c to the measurement APL 201b of the server 2.

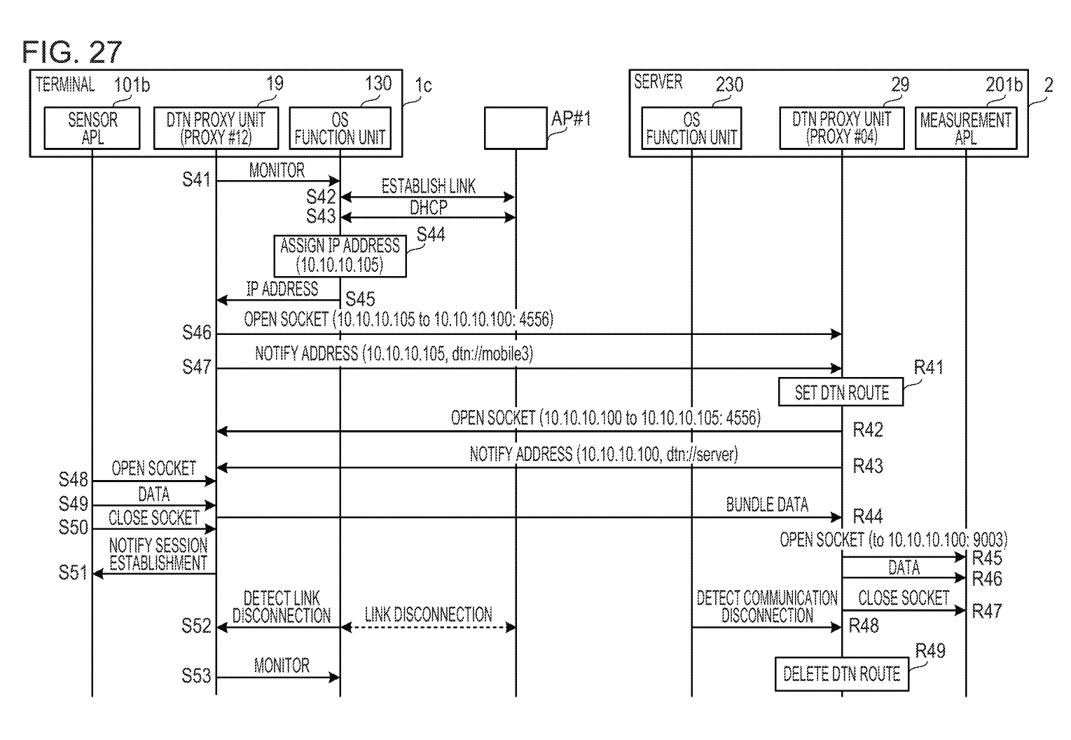

FIG. 27 illustrates the communication operation between the sensor APL 101b of the terminal 1c, the DTN proxy unit 19 including the proxy #12, and the OS function unit 130 and the measurement APL 201b of the server 2, the DTN proxy unit 29 including the proxy #04, and the OS function unit 230. This example illustrates the communication when the terminal 1c is linked with the wireless access point AP #1.

The DTN proxy unit 19 of the terminal 1c monitors the OS function unit 130 in order to detect the assignment of an IP address (reference numeral S41). When the terminal 1c enters the coverage area of the wireless LAN #11, the OS function unit 130 establishes a link with the wireless access point AP #1 (reference numeral S42). The OS function unit 130 performs DHCP communication with the wireless access point AP #1 (reference numeral S43), and the IP address “10.10.10.105” is assigned to the terminal 1c (reference numeral S44). The DTN proxy unit 19 acquires the IP address from the OS function unit 130 (reference numeral S45).

The DTN proxy unit 19 opens a socket to the DTN proxy unit 29 as the communication destination (reference numeral S46). This socket corresponds to the socket SC3 in FIG. 10, and its communication destination is the IP address “10.10.10.100” and the port number “4556” of the bundle control unit 220. The DTN proxy unit 19 generates an address notification including the IP address “10.10.10.105” and the node EID “dtn://mobile3” for transmission to the DTN proxy unit 29 of the server 2 (reference numeral S47).

When receiving an address notification, the DTN proxy unit 29 acquires an IP address from the address notification and sets the IP address in the DTN route TBL 223 so that it corresponds to the node EID in the address notification (reference numeral R41). More specifically, the route control unit 224 sets the transmission source IP address of the address notification in the DTN route TBL 223 so that it corresponds to the destination EID of the address notification. Note that the setting content is as described with reference to FIG. 21.

The DTN proxy unit 29 opens a socket to the DTN proxy unit 19 as the communication destination (reference numeral R42). This socket corresponds to the socket SC4 in FIG. 10, and its communication destination is the IP address “10.10.10.105” and the port number “4556” of the bundle control unit 120. The DTN proxy unit 29 generates an address notification including the IP address “10.10.10.100” and the node EID “dtn://server” for transmission to the DTN proxy unit 19 of the terminal 1c (reference numeral R43).

The sensor APL 101b of the terminal 1c opens a socket to the DTN proxy unit 19 (reference numeral S48). This socket corresponds to the socket SC1 in FIG. 10, and its communication destination is the IP address “10.10.10.105” and the port number “8001” of the proxy #12. The sensor APL 101b transmits data from the socket to the DTN proxy unit 19 (reference numeral S49). The DTN proxy unit 19 transmits bundle data to the DTN proxy unit 29 of the server 2 (reference numeral R44).

Upon completion of the data transmission, the sensor APL 101b closes the socket (reference numeral S50). In addition, the DTN proxy unit 19 notifies the sensor APL 101b of establishment of a session (reference numeral S51).

The DTN proxy unit 29 of the server 2 opens a socket to the measurement APL 201b as the communication destination (reference numeral R45). This socket corresponds to the socket SC5 in FIG. 10. The DTN proxy unit 29 transmits data from the socket to the measurement APL 201b (reference numeral R46) and closes the socket (reference numeral R47).

When the terminal 1c moves out of the coverage area of the wireless LAN #11, the link between the terminal 1c and the wireless access point AP #1 is disconnected. The DTN proxy unit 19 detects link disconnection by the OS function unit 130 (reference numeral S52). The DTN proxy unit 19 again monitors the OS function unit 130 in preparation for the link with another wireless access point AP (reference numeral S53). Thereafter, the sequence of this example is repeated. As described above, communication from the sensor APL 101b to the measurement APL 201b is performed. Note that each of the sequences described above is executed in the same way for the other terminals 1a and 1b.

Additionally, it is possible to perform the processing functions described above using a computer. In that case, a program stating the processing content of the functions to be possessed by the processing device is provided. Execution of the program with a computer achieves the processing functions described above on the computer. It is possible to store the program stating the processing content in a computer-readable recording medium (excluding a carrier wave).

In the case of distributing a program, the program is sold in the form of, for example, a portable recording medium such as a digital versatile disc (DVD) or a compact disc read only memory (CD-ROM) containing the program recorded therein. Moreover, the program may be stored in the storage device of a server computer, and the program may be forwarded from the server computer to another computer via a network.

For example, the computer for executing the program stores in its own storage device the program recorded in the portable recording medium or the program forwarded from the server computer. Then, the computer reads the program from its own storage device to execute the processing in accordance with the program. Note that the computer may read a program directly from a portable recording medium to execute the processing in accordance with the program. Furthermore, the computer may sequentially execute the processing in accordance with the received program each time a program is forwarded from the server computer.

The embodiment described above is a preferred embodiment of the present invention. However, the present invention is not limited to the above embodiment, and various modifications may be made without departing from the gist of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication system comprising:
a server, in which a first application operates, configured to include:
a first memory, and
a first processor coupled to the first memory and the first processor configured to relay communication addressed from the first application to a second application for operating in a terminal; and
the terminal configured to include:
a second memory, and
a second processor coupled to the second memory and the second processor configured to forward the communication relayed from the first application to the second application,
each of the first processor and the second processor is configured to generate a communication route corresponding to a session established by communication between the first application and the second application, and maintain the session by using the communication route while switching a network that includes the terminal.

2. The communication system according to claim 1,
wherein each of the first processor and the second processor is configured to use the communication route to continue the communication, addressed from the first application to the second application, interrupted by the switching of the network.

3. The communication system according to claim 1,
wherein the first processor is configured to notify the first application of establishment of the session, when requested by the first application for communication with the second application, and
wherein the second processor is configured to establish the session with the second application in response to a notification from the first processor, after the switching of the network.

4. The communication system according to claim 1,
wherein the second processor is configured to notify the first processor of identification information of the terminal in the network after the switching, and
wherein the first processor is configured to generate the communication route based on the identification information.

5. A terminal comprising:
a memory; and
a processor coupled to the memory and the processor configured to:
forward communication, addressed from a first application that operates in a server to a second application, relayed from the server to the second application;
generate a communication route corresponding to a session established by communication between the first application and the second application; and
maintain the session by using the communication route while switching a network that includes the terminal.

6. The terminal according to claim 5,
wherein the processor is configured to use the communication route to continue the communication, addressed from the first application to the second application, interrupted by the switching of the network.

7. The terminal according to claim 5,
wherein the processor is configured to notify the server of identification information of the terminal in the network after the switching.

8. A server comprising:
a memory; and
a processor coupled to the memory and the processor configured to:
relay communication from a first application that operates in the server to a second application that operates in a terminal to the terminal;
generate a communication route corresponding to a session established by communication between the first application and the second application; and
maintain the session by using the communication route while switching a network that includes the terminal.

9. The server according to claim 8,
wherein the processor is configured to use the communication route to continue the communication, addressed from the first application to the second application, interrupted by the switching of the network.
